(19) United States
(12) Patent Application Publication
(10) Pub. No.: US 2026/0058878 A1
(43) Pub. Date: Feb. 26, 2026

(54) BUILDING MANAGEMENT SYSTEM WITH AUTOCONFIGURATION

(71) Applicant: Tyco Fire & Security GmbH, Neuhausen am Rheinfall (CH)

(72) Inventors: Sudhanshu Dixit, Milwaukee, WI (US); Nicolae Bogdan Pavel, Cork (IE); Sunny Shekhar, Milwaukee, WI (US); Risavsingh Virendrakumar Saingar, Pune (IN); Dominick J. O'Dierno, Mt Pleasant, WI (US); Priya Agarwal, Montville, NJ (US)

(21) Appl. No.: 19/307,829

(22) Filed: Aug. 22, 2025

(30) Foreign Application Priority Data
Aug. 23, 2024 (IN) 202441063860

(51) Int. Cl. H04L 41/12; H04L 41/16; H04L 41/22

(52) U.S. Cl. CPC H04L 41/12; H04L 41/16; H04L 41/22

(57) ABSTRACT

A Building Management System (BMS) can include one or more memory devices storing instructions thereon that, when executed by one or more processors, cause the one or more processors to receive a selection of a building, perform a search on a network of the building for a plurality of pieces of equipment or a plurality of datapoints associated with the plurality of pieces of equipment, discover at least one piece of equipment of the plurality of pieces of equipment or one or more datapoints of the plurality of datapoints, update the user interface to display a graphical representation of the at least one piece of equipment or the one or more datapoints, and prompt a machine learning model to generate at least one classification for the at least one piece of equipment or the one or more datapoints.

### CROSS-REFERENCE TO RELATED PATENT APPLICATIONS

This application claims the benefit of and priority to Indian Provisional Patent Application No. 202441063860, filed Aug. 23, 2024, the entirety of which is incorporated by reference herein.

### BACKGROUND

A Building Management System (BMS) or Building Automation System (BAS) is, in general, a system of devices configured to control, monitor, and/or manage equipment in or around a building or building area. A BMS or BAS can include, for example, a HVAC system, a security system, a lighting system, a fire alerting system, any other system that is capable of managing building functions or devices, or any combination thereof. The terms BMS and BAS are used interchangeably for the purposes of the present disclosure.

A BAS may be controllable from a localized and/or an onsite premise. For example, a BAS may be controllable by an admin within a building. The admin may control the BAS using a computing device (e.g., a desktop computer).

Many BAS or BMS systems contain separate subsystems to store value data, authorization data, and semantic data. Additionally, many of these systems transmit all stored data to the BMS on request. Transmitting data from separate subsystems, each of which contain large quantities of data, may result in unnecessary time delays. It would be desirable to aggregate measured and transmitted data in a manner that may be quickly transmitted and easily accessible across building systems.

### SUMMARY

At least one embodiment relates to a Building Management System (BMS). The BMS can include one or more memory devices. The one or more memory devices can store instructions thereon that, when executed by one or more processors, cause the one or more processors to receive, via a user interface, a selection of a building. The instructions can cause the one or more processors to perform, responsive to receipt of a request via the user interface, a search on a network of the building for a plurality of pieces of equipment or a plurality of datapoints associated with the plurality of pieces of equipment. The instructions can cause the one or more processors to discover, responsive to performance of the search on the network, at least one piece of equipment of the plurality of pieces of equipment or one or more datapoints of the plurality of datapoints. The instructions can cause the one or more processors to update the user interface to display a graphical representation of the at least one piece of equipment or the one or more datapoints. The instructions can cause the one or more processors to prompt a machine learning model to generate at least one classification for the at least one piece of equipment or the one or more datapoints. The instructions can cause the one or more processors to update, responsive to generation of the at least one classification, the user interface to display the at least one classification. The instructions can cause the one or more processors to store, responsive to an acceptance of the at least one classification, the at least one classification in a database associated with the building to integrate the at least one piece of equipment or the one or more datapoints with the building.

In some embodiments, at least one second piece of equipment of the plurality of pieces of equipment can be integratable with the building without a subsequent selection of the building via the user interface.

In some embodiments, the instructions can cause the one or more processors to receive, via the user interface, a second selection to display a spatial hierarchy of the building. The instructions can cause the one or more processors to retrieve, responsive to receipt of the second selection, a set of data that represents the spatial hierarchy of the building. The instructions can cause the one or more processors to display, via the user interface, a graphical representation of the spatial hierarchy of the building. The instructions can cause the one or more processors to receive, via the user interface, an input to add a space to the spatial hierarchy of the building. The instructions can cause the one or more processors to update, responsive to receipt of the input, the spatial hierarchy to include the space.

In some embodiments, the update to the spatial hierarchy can occur without a subsequent selection of the building via the user interface.

In some embodiments, the at least one classification can include a first classification associated with the at least one piece of equipment and a second classification associated with the one or more datapoints. The instructions can cause the one or more processors to receive, via the user interface, a second selection of the graphical representation of the at least one piece of equipment. The instructions can cause the one or more processors to update, responsive to receipt of the second selection, the user interface to display the first classification and the second classification. The instructions can cause the one or more processors to receive, via the user interface, a third selection of an element to indicate the acceptance of the at least one classification.

In some embodiments, the database associated with the building can include (1) a first classification of at least one previously discovered piece of equipment and (2) a second classification of at least one datapoint associated with the at least one previously discovered piece of equipment. The instructions can cause the one or more processors to receive, via the user interface, a second selection of the at least one previously discovered piece of equipment. The instructions can cause the one or more processors to update, responsive to receipt of the second selection, the user interface to display the first classification and the second classification. The instructions can cause the one or more processors to receive, via the user interface, an adjustment to the first classification or the second classification. The instructions can cause the one or more processors to update the database associated with the building to reflect the adjustment without a subsequent selection of the building via the user interface.

In some embodiments, the database associated with the building can include a virtual representation of the building. The virtual representation of the building can be a digital twin. The instructions can cause the one or more processors to detect, responsive to a query of the digital twin, one or more changes with respect to the building. The instructions can cause the one or more processors to prompt the machine learning model to generate one or more mappings to reflect the one or more changes.

In some embodiments, the one or more changes can include at least one of an addition of a first piece of building equipment to the building, a removal of a second piece of building equipment from the building, or an adjustment to a classification between at least one datapoint and a third piece of building equipment.

In some embodiments, the user interface can provide, prior to receipt of the selection of the building, a first view that includes (1) an indication of the building and (2) an indication of information associated with the building. The instructions can cause the one or more processors to update, responsive to receipt of the selection, the user interface to provide a second view that includes a first element associated with one or more spaces of the building, a second element associated with one or more devices of the building, a third element associated with at least one previously discovered datapoint, and a fourth element associated with at least one previously discovered piece of equipment. The instructions can cause the one or more processors to receive, via the user interface, a selection of the fourth element. The instructions can cause the one or more processors to update the user interface to include (1) information associated with the at least one previously discovered piece of equipment and (2) a fifth element to interact with to provide the request to search the network of the building. The instructions can cause the one or more processors to receive the request to search the network of the building responsive to an interaction with the fifth element.

In some embodiments, the at least one piece of equipment can be discovered as a first unstructured object name. The one or more datapoints can be discovered as a second unstructured object name. The first unstructured object name and the second unstructured object name can be provided to the machine learning model as one or more inputs. The machine learning model can generate the at least one classification by generating a plurality of standardized object names based on the one or more inputs, determining a probability for each standardized object name of the plurality of standardized object names that indicates a likelihood that a corresponding standardized object name is associated with the first unstructured object name or the second unstructured object name, and selecting, based on the probability for each standardized object name of the plurality of standardized object names, at least one standardized object name as the at least one classification.

At least one embodiment relates to one or more non-transitory storage media. The one or more non-transitory storage media can store instructions thereon. The instructions can, when executed by one or more processors, cause the one or more processors to perform operations. The operations can include performing, responsive to receiving a request via a user interface, a search on a network of a building for a plurality of pieces of equipment or a plurality of datapoints. The operations can include discovering, responsive to performing the search on the network, at least one piece of equipment of the plurality of pieces of equipment or one or more datapoints of the plurality of datapoints. The operations can include updating the user interface to display a graphical representation of the at least one piece of equipment or the one or more datapoints. The operations can include prompting a machine learning model to generate at least one classification for the at least one piece of equipment or the one or more datapoints. The operations can include updating, responsive to generating the at least one classification, the user interface to display the at least one classification. The operations can include storing, responsive to an acceptance of the at least one classification, the at least one classification in a database associated with the building to integrate the at least one piece of equipment or the one or more datapoints with the building.

In some embodiments, at least one second piece of equipment of the plurality of pieces of equipment can be integratable with the building without a subsequent selection of the building via the user interface.

In some embodiments, the operations can include receiving, via the user interface, a selection to display a spatial hierarchy of the building. The operations can include retrieving, responsive to receiving the selection, a set of data that represents the spatial hierarchy of the building. The operations can include displaying, via the user interface, a graphical representation of the spatial hierarchy of the building. The operations can include receiving, via the user interface, an input to add a space to the spatial hierarchy of the building. The operations can include updating, responsive to receiving the input, the spatial hierarchy to include the space.

In some embodiments, the at least one classification can include a first classification associated with the at least one piece of equipment and a second classification associated with the one or more datapoints. The operations can include receiving, via the user interface, a first selection of the graphical representation of the at least one piece of equipment. The operations can include updating, responsive to receiving the first selection, the user interface to display the first classification and the second classification. The operations can include receiving, via the user interface, a second selection of an element to indicate the acceptance of the at least one classification.

In some embodiments, the database associated with the building can include (1) a first classification of at least one previously discovered piece of equipment and (2) a second classification of at least one datapoint associated with the at least one previously discovered piece of equipment. The operations can include receiving, via the user interface, a selection of the at least one previously discovered piece of equipment. The operations can include updating, responsive to receiving the selection, the user interface to display the first classification and the second classification. The operations can include receiving, via the user interface, an adjustment to the first classification or the second classification. The operations can include updating the database associated with the building to reflect the adjustment without a subsequent selection of the building via the user interface.

In some embodiments, the database associated with the building can include a virtual representation of the building. The virtual representation of the building can be a digital twin. The operations can include detecting, responsive to querying the digital twin, one or more changes with respect to the building. The operations can include prompting the machine learning model to generate one or more mappings to reflect the one or more changes.

In some embodiments, the user interface can provide a first view that includes (1) an indication of the building and (2) an indication of information associated with the building. The operations can include updating the user interface to provide a second view that includes a first element associated with one or more spaces of the building, a second element associated with one or more devices of the building, a third element associated with at least one previously discovered datapoint, and a fourth element associated with at least one previously discovered piece of equipment. The operations can include receiving, via the user interface, a selection of the fourth element. The operations can include updating the user interface to include (1) information associated with the at least one previously discovered piece of equipment and (2) a fifth element to interact with to provide the request to search the network of the building. The operations can include receiving the request to search the network of the building responsive to an interaction with the fifth element.

At least one embodiment relates to a Building Management System (BMS). The BMS can include one or more memory devices. The one or more memory devices can store instructions thereon that, when executed by one or more processors, cause the one or more processors to provide, via a display device, a user interface having a first view. The first view can include (1) an indication of a building associated with the BMS and (2) an indication of information associated with the building. The instructions can cause the one or more processors to receive, via the user interface, a first selection of the building. The instructions can cause the one or more processors to update the user interface to have a second view. The second view can include a spatial hierarchy of the building. The instructions can cause the one or more processors to receive one or more subsequent interactions with the user interface having the second view. The one or more subsequent interactions can include at least one of (1) one or more updates to the spatial hierarchy of the building or (2) one or more integrations of equipment and/or datapoints with the BMS. The instructions can cause the one or more processors to generate an association between the one or more subsequent interactions and the building without a second selection of the building.

In some embodiments, the instructions can cause the one or more processors to generate the association between the one or more subsequent interactions and the building by updating a database associated with the building to include the one or more updates to the spatial hierarchy or the one or more integrations of the equipment and/or the datapoints with the BMS.

In some embodiments, the one or more subsequent interactions can include the one or more integrations of the equipment and/or the datapoints with the BMS. The instructions can cause the one or more processors to generate the association between the one or more subsequent interactions and the building by prompting a machine learning (ML) model to generate one or more classifications for the equipment or the datapoints, updating, responsive to generation of the one or more classifications, the user interface to display the one or more classifications, and storing, responsive to an acceptance of the one or more classifications, the one or more classifications in a database associated with the building to integrate the equipment and/or the datapoints with the BMS.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a drawing of a building equipped with a heating, ventilating, and air conditioning (HVAC) system, according to some embodiments.

FIG. 2 is a block diagram of a building management system (BMS) which can be used to monitor and control the building and HVAC system of FIG. 1, according to some embodiments.

FIG. 3 is a block diagram of a system to integrate one or more buildings and/or one or more portions thereof with a building management system, according to some embodiments.

FIG. 4 is a data flow chart illustrating communication between one or more components of a system architecture, according to some embodiments.

FIG. 5 is a user interface including a location view, according to some embodiments.

FIG. 6 is a user interface including information associated with a location, according to some embodiments.

FIG. 7 is a user interface including a space view, according to some embodiments.

FIG. 8 is a user interface including information associated with a space of a building, as illustrated in FIG. 7, according to some embodiments.

FIG. 9 is a user interface including a device view, according to some embodiments.

FIG. 10 is a user interface including an equipment view, according to some embodiments.

FIG. 11 is a user interface including information associated with a piece of building equipment of a building, according to some embodiments.

FIG. 12 is a user interface including a points view, according to some embodiments.

FIG. 13 is a user interface including information associated with a point, according to some embodiments.

FIG. 14 is a user interface including a points view, according to some embodiments.

FIG. 15 is a user interface including a window to update point configurations, according to some embodiments.

FIG. 16 is a user interface including an equipment view, according to some embodiments.

FIG. 17 is a user interface including a window to configure pieces of building equipment, according to some embodiments.

FIG. 18 is a user interface including a window to select an adjustment option, according to some embodiments.

FIG. 19 is a user interface including a window to rename pieces of building equipment, according to some embodiments.

FIG. 20 is a user interface including a space view, according to some embodiments.

FIG. 21 is a user interface including a window to indicate data published to a remote server, according to some embodiments.

FIG. 22 is a sequence diagram illustrating a data flow between one or more components of the system architecture illustrated in FIG. 4, according to some embodiments.

FIG. 23 is a flow diagram of a method, according to some embodiments.

### DETAILED DESCRIPTION

### Overview

Referring generally to the FIGURES, a building management system (BMS) with automatic discovery and building integration is shown, according to some embodiments. A BMS is, in general, a system of devices configured to control, monitor, and manage equipment in or around a building or building area. A BMS can include a heating, ventilation, or air conditioning (HVAC) system, a security system, a lighting system, a fire alerting system, another system that is capable of managing building functions or devices, or any combination thereof. BMS devices may be installed in any environment (e.g., an indoor area or an outdoor area) and the environment may include any number of buildings, spaces, zones, rooms, or areas.

In brief overview, the BMS described herein provides a system architecture that facilitates datapoint classifications to integrate one or more devices with the BMS. For example, when a controller is connected to a network, the BMS may discover (e.g., detect) the controller. To continue this example, models (e.g., machine learning (ML) models, artificial intelligence (AI) models, transformers, etc.) may execute one or more functions to classify and/or describe the controller. BMSs and/or one or more aspects thereof (e.g., equipment, data sources, building specifications, etc.) may be stored as virtual representations. For example, a BMS and/or a building serviced by the BMS may be stored as a digital twin. Virtual representations of a building may include various hierarchies and/or levels. For example, a building may include spatial hierarchies such as, sites, spaces, devices, points, equipment, and meters. Each level or portion of the spatial hierarchy relates to one or more additional levels. For example, a space (e.g., room, zone, section, segment, etc.) relates to a building that includes the space. As another example, one or more pieces of equipment may relate to the space when the one or more pieces of equipment service the space.

When equipment and/or devices are added to a virtual representation of a building, the equipment and/or devices are classified in accordance with the spatial hierarchy. For example, an air handler unit (AHU) that services a given room of a building, may be classified as a device that circulates air in the given room of the building. In this example, the AHU would be classified under (1) a building that includes the given room, (2) a floor that includes the given room, (3) a zone of the floor that includes the given room, and (4) the given room. As illustrated in the above example, spatial hierarchy for equipment and/or devices can be complex and/or convoluted as equipment can include several hierarchy levels.

When a given piece of equipment is discovered, classified, and/or integrated with the BMS, the inter-relationships between levels of the spatial hierarchy are indicated and/or selected by one or more interactions with an onboarding tool (e.g., a user interface, a web portal, a website, etc.). Additionally, when onboarding equipment it is difficult to correctly identify new equipment or what equipment points are associated with as most points are not human readable. Moreover, onboarding equipment is a manual and time consuming process that involves extensive manual human intervention and associated computing and other resources. As a result of the manual onboarding process, equipment classification is prone to incorrect classification of points and equipment which results in equipment not operating properly or not operating at all given the equipment being misclassified. Misclassification of equipment further leads to problems associated with occupant experience, energy efficiency, and building emissions.

While onboarding tools may assist with the manual onboarding process, these onboarding tools are not arranged to restrict operations to a given building or sub-level thereof. As a result, when a second piece of equipment is discovered the inter-relationships between levels are prompted for once again by the onboarding tools. As an example, other onboarding tools may prompt a user to indicate a given building, zone, space, etc. for each piece of equipment that may be integrated with the building. This arrangement requires users to repeatedly present and/or indicate spatial hierarchy even if subsequent pieces of equipment had the same hierarchy. Stated otherwise, the manual onboarding process is inefficient as user interfaces (UI) and/or user experiences (UX) force users to repeatedly identify and specify building/spaces as opposed to interfaces that allow drilling down on space and then doing discovery particular to that space.

Some technical solutions described herein include a system architecture that includes knowledge regarding the spatial hierarchy such that multiple pieces of equipment may be integrated and/or classified without multiple indications of the spatial hierarchy. For example, the system architecture may include an application (e.g., an onboarding tool, equipment integrator, data classifier, etc.) that restricts operations to a given building without having multiple indications of the building. Stated otherwise, the application can present information associated with equipment integration for a given building and while equipment is being integrated with the given building, the application does not repeatedly prompt for the spatial hierarchy.

Additionally, the application may present one or more user interfaces in accordance with given levels of the spatial hierarchy. For example, the application may present a user interface that includes a building and/or site view. From the user interface, one or more subsequent views (e.g., space view, device view, point view, equipment view, meter view, etc.) may be reached and/or presented. For example, the user interface may include hyperlinks and/or selectable icons that cause the user interface to be updated and/or replaced with information associated with a given view. The application may restrict and/or control onboarding actions in accordance with a view of the user interface. For example, the application may restrict actions to a building level of the spatial hierarchy while a user is interacting with a building view. As another example, the application may restrict actions to a space level of the spatial hierarchy while a user is interacting with a space view. As another example, the application may present a user interface for which a site (e.g., a location, a building, etc.) can be created and all operations performed with the user interface can be restricted and/or performed with respect to the site.

Systems, devices, components, and/or entities of a building may produce information. For example, pieces of building equipment may produce, provide, and/or generate one or more types of information. As another example, a sensor may collect temperature information and the sensor may generate information that identifies and/or includes the collected temperature information. As another example, when a building access system grants access to a building (e.g., unlocks a door), the building access system may generate information that identifies an individual that was granted access. The various types of information that is generated by pieces of building equipment may be transmitted, transferred, and/or otherwise provided to various systems. For example, the zone temperature readings may be provided to a processing system. To continue this example, the processing system may generate control signals based on the zone temperature readings.

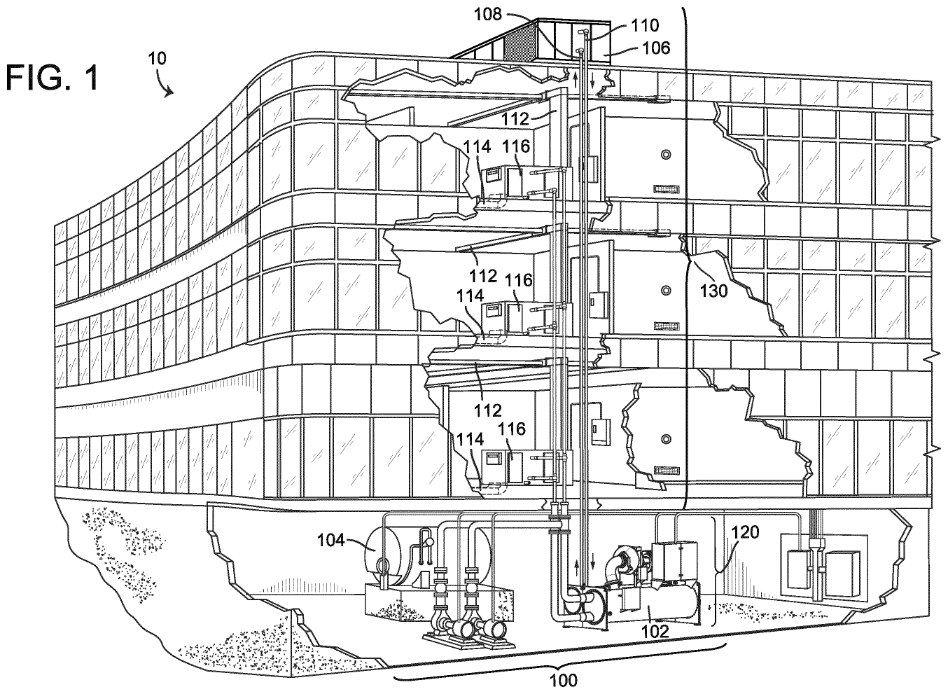

Referring now to FIG. 1, an exemplary building and HVAC system in which the systems and methods of the present invention can be implemented are shown, according to an exemplary embodiment. In FIG. 1, a perspective view of a building 10 is shown. Building 10 is served by a HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 can provide a heated or chilled fluid to an air handling unit of airside system 130. Airside system 130 can use the heated or chilled fluid to heat or cool an airflow provided to building 10.

HVAC system 100 is shown to include a chiller 102, a boiler 104, and a rooftop air handling unit (AHU) 106. Waterside system 120 can use boiler 104 and chiller 102 to heat or cool a working fluid (e.g., water, glycol, etc.) and can circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 can add heat to the circulated fluid, for example, by burning a combustible material (e.g., natural gas) or using an electric heating element. Chiller 102 can place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 can place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 can transfer heat between the airflow and the working fluid to provide heating or cooling for the airflow. For example, AHU 106 can include one or more fans or blowers configured to pass the airflow over or through a heat exchanger containing the working fluid. The working fluid can then return to chiller 102 or boiler 104 via piping 110.

Airside system 130 can deliver the airflow supplied by AHU 106 (i.e., the supply airflow) to building 10 via air supply ducts 112 and can provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 can receive input from sensors located within AHU 106 and/or within the building zone and can adjust the flow rate, temperature, or other attributes of the supply airflow through AHU 106 to achieve setpoint conditions for the building zone.

### Building Management System

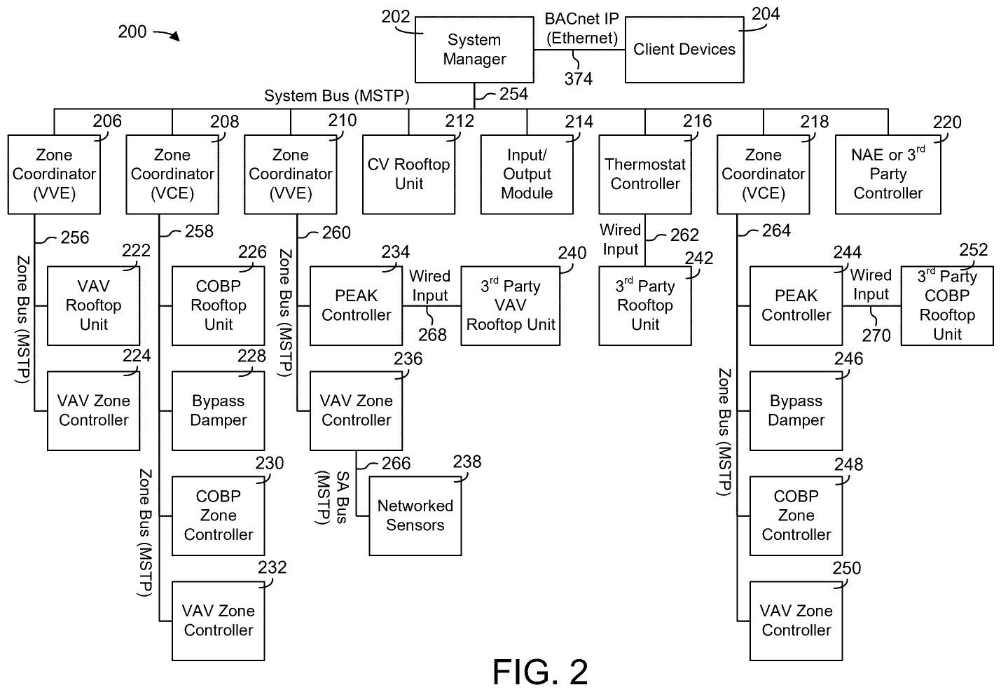

Referring now to FIG. 2, a block diagram of a building management system (shown as BMS 200) is shown, according to an exemplary embodiment. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof. BMS 200 can be used to monitor and control the devices of HVAC system 100 and/or airside system 130 (e.g., HVAC equipment) as well as other types of BMS devices (e.g., lighting equipment, security equipment, etc.).

In brief overview, BMS 200 provides a system architecture that facilitates automatic equipment discovery and equipment model distribution. Equipment discovery can occur on multiple levels of BMS 200 across multiple different communications buses (e.g., a system bus 254, zone buses 256-260 and 264, sensor/actuator (SA) bus 266, etc.) and across multiple different communications protocols. In some embodiments, equipment discovery is accomplished using active node tables, which provide status information for devices connected to each communications bus. For example, each communications bus can be monitored for new devices by monitoring the corresponding active node table for new nodes. When a new device is detected, BMS 200 can begin interacting with the new device (e.g., sending control signals, using data from the device) without user interaction.

Some devices in BMS 200 present themselves to the network using equipment models. An equipment model defines equipment object attributes, view definitions, schedules, trends, and the associated BACnet value objects (e.g., analog value, binary value, multistate value, etc.) that are used for integration with other systems. An equipment model for a device can include a collection of point objects that provide information about the device (e.g., device name, network address, model number, device type, etc.) and store present values of variables or parameters used by the device. For example, the equipment model can include point objects (e.g., standard BACnet point objects) that store the values of input variables accepted by the device (e.g., setpoint, control parameters, etc.), output variables provided by the device (e.g., temperature measurement, feedback signal, etc.), configuration parameters used by the device (e.g., operating mode, actuator stroke length, damper position, tuning parameters, etc.). The point objects in the equipment model can be mapped to variables or parameters stored within the device to expose those variables or parameters to external systems or devices.

Some devices in BMS 200 store their own equipment models. Other devices in BMS 200 have equipment models stored externally (e.g., within other devices). For example, a zone coordinator 208 can store the equipment model for a bypass damper 228. In some embodiments, zone coordinator 208 automatically creates the equipment model for bypass damper 228 or other devices on zone bus 258. Other zone coordinators can also create equipment models for devices connected to their zone buses. The equipment model for a device can be created automatically based on the types of data points exposed by the device on the zone bus, device type, and/or other device attributes. Several examples of automatic equipment discovery and equipment model distribution are discussed in greater detail below.

Still referring to FIG. 2, BMS 200 is shown to include a system manager 202; several zone coordinators 206, 208, 210 and 218; and several zone controllers 224, 230, 232, 236, 248, and 250. System manager 202 can communicate with client devices 204 (e.g., user devices, desktop computers, laptop computers, mobile devices, etc.) via a data communications link 374 (e.g., BACnet IP, Ethernet, wired or wireless communications, etc.). System manager 202 can provide a user interface to client devices 204 via data communications link 374. The user interface may allow users to monitor and/or control BMS 200 via client devices 204.

In some embodiments, system manager 202 is connected with zone coordinators 206-210 and 218 via a system bus 254. System bus 254 can include any of a variety of communications hardware (e.g., wire, optical fiber, terminals, etc.) configured to facilitate communications between system manager and other devices connected to system bus 254. Throughout this disclosure, the devices connected to system bus 254 are referred to as system bus devices. System manager 202 can be configured to communicate with zone coordinators 206-210 and 218 via system bus 254 using a master-slave token passing (MSTP) protocol or any other communications protocol. System bus 254 can also connect system manager 202 with other devices such as a constant volume (CV) rooftop unit (RTU) 212, an input/output module (IOM) 214, a thermostat controller 216 (e.g., a TEC2000 series thermostat controller), and a network automation engine (NAE) or third-party controller 220. RTU 212 can be configured to communicate directly with system manager 202 and can be connected directly to system bus 254. Other RTUs can communicate with system manager 202 via an intermediate device. For example, a wired input 262 can connect a third-party RTU 242 to thermostat controller 216, which connects to system bus 254.

System manager 202 can provide a user interface for any device containing an equipment model. Devices such as zone coordinators 206-210 and 218 and thermostat controller 216 can provide their equipment models to system manager 202 via system bus 254. In some embodiments, system manager 202 automatically creates equipment models for connected devices that do not contain an equipment model (e.g., IOM 214, third party controller 220, etc.). For example, system manager 202 can create an equipment model for any device that responds to a device tree request. The equipment models created by system manager 202 can be stored within system manager 202. System manager 202 can then provide a user interface for devices that do not contain their own equipment models using the equipment models created by system manager 202. In some embodiments, system manager 202 stores a view definition for each type of equipment connected via system bus 254 and uses the stored view definition to generate a user interface for the equipment.

Each zone coordinator 206-210 and 218 can be connected with one or more of zone controllers 224, 230-232, 236, and 248-250 via zone buses 256, 258, 260, and 264. Zone buses 256, 258, 260, and 264 can include any of a variety of communications hardware (e.g., wire, optical fiber, terminals, etc.) configured to facilitate communications between a zone coordinator and other devices connected to the corresponding zone bus. Throughout this disclosure, the devices connected to zone buses 256, 258, 260, and 264 are referred to as zone bus devices. Zone coordinators 206-210 and 218 can communicate with zone controllers 224, 230-232, 236, and 248-250 via zone buses 256-260 and 264 using a MSTP protocol or any other communications protocol. Zone buses 256-260 and 264 can also connect zone coordinators 206-210 and 218 with other types of devices such as variable air volume (VAV) RTUs 222 and 240, changeover bypass (COBP) RTUs 226 and 252, bypass dampers 228 and 246, and PEAK controllers 234 and 244.

Zone controllers 224, 230-232, 236, and 248-250 can communicate with individual BMS devices (e.g., sensors, actuators, etc.) via sensor/actuator (SA) buses. For example, VAV zone controller 236 is shown connected to networked sensors 238 via SA bus 266. Networked sensors 238 can include, for example, temperature sensors, humidity sensors, pressure sensors, lighting sensors, security sensors, or any other type of device configured to measure and/or provide an input to zone controller 236. Zone controller 236 can communicate with networked sensors 238 using a MSTP protocol or any other communications protocol. Although only one SA bus 266 is shown in FIG. 2, it should be understood that each zone controller 224, 230-232, 236, and 248-250 can be connected to a different SA bus. Each SA bus can connect a zone controller with various sensors (e.g., temperature sensors, humidity sensors, pressure sensors, light sensors, occupancy sensors, etc.), actuators (e.g., damper actuators, valve actuators, etc.) and/or other types of controllable equipment (e.g., chillers, heaters, fans, pumps, etc.).

Each zone controller 224, 230-232, 236, and 248-250 can be configured to monitor and control a different building zone. Zone controllers 224, 230-232, 236, and 248-250 can use the inputs and outputs provided via their SA buses to monitor and control various building zones. For example, a zone controller 236 can use a temperature input received from networked sensors 238 via SA bus 266 (e.g., a measured temperature of a building zone) as feedback in a temperature control algorithm. Zone controllers 224, 230-232, 236, and 248-250 can use various types of control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control a variable state or condition (e.g., temperature, humidity, airflow, lighting, etc.) in or around building 10.

### Equipment and Point Classification Autoconfiguration

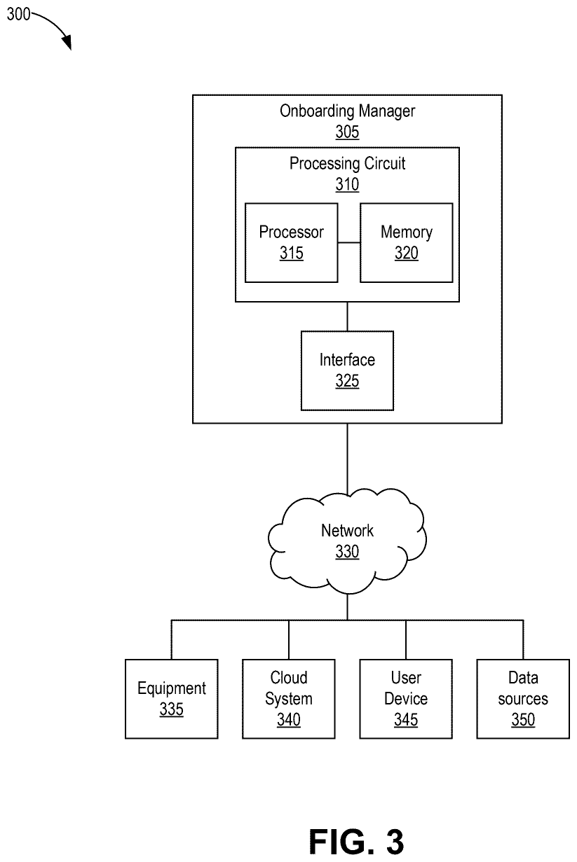

FIG. 3 depicts a block diagram of a system 300, according to some embodiments. The system 300 may include and/or be implemented as at least one of the various systems described herein. For example, the system 300 may be implemented as the BMS 200. In some embodiments, the system 300 may include at least one of the various systems and/or components described herein. For example, the system 300 may include the system manager 202. In some embodiments, systems, components, and/or devices of the system 300 may be added, removed, integrated, combined, separated, rearranged, relocated, and/or replaced. For example, a device of the system 300 that may be shown to include two components may be modified such that the two components are combined into a single component. As another example, a component that is shown to be included in a first device may also be added to a second device.

In some embodiments, each system and/or component of the system 300 can include one or more processors, memory, memory devices, network interfaces, communication interfaces, and/or user interfaces. Memory can store programming logic that, when executed by the processors, controls the operation of the corresponding computing system or device. Memory can also store data in databases. The network interfaces can allow the systems and/or components of the system 300 to communicate wirelessly. The communication interfaces can include wired and/or wireless communication interfaces and the systems and/or components of the system 300 can be connected via the communication interfaces. The various components in the system 300 can be implemented via hardware (e.g., circuitry), software (e.g., executable code), or any combination thereof.

In some embodiments, the system 300 can include at least one onboarding manager 305, at least one network 330, at least one piece of equipment 335, at least one cloud system 340, at least one user device 345, and at least one data source 350. At least one system, device, and/or component of the system 300 can perform similar functionality to that of at least one system, device, and/or component described herein. For example, the onboarding manager 305 can perform functions similar to that of the BMS 200. In some embodiments, the network 330 can be and/or include at least one of a local area network (LAN), wide area network (WAN), telephone network (such as the Public Switched Telephone Network (PSTN)), Controller Area Network (CAN), wireless link, intranet, the Internet, a cellular network, and/or combinations thereof.

In some embodiments, an operator of the user devices 345 can perform various actions and/or access various types of information. The information can be provided over the network 330 (e.g., the Internet, LAN, WAN, cellular, etc.). In some embodiments, the user devices 345 can perform similar functionality to that of at least one component of the system 300. For example, the user devices 345 can perform similar functionality to that of the cloud system 340. The user devices 345 can include an application to receive information, display information, and/or receive user interactions with content displayed by the user devices 345.

In some embodiments, the user devices 345 can be and/or include at least one of a screen, a monitor, a visual display device, a touchscreen display, a television, a video display, a liquid crystal display (LCD), a light emitting diode (LED) display, a mobile device, a kiosk, a digital terminal, and/or among other possible displays and/or devices. For example, the user devices 345 can be touchscreen displays that include a resistive touchscreen that can receive user input via interactions (e.g., touches) with the touchscreen. In some embodiments, the user devices 345 can be in communication with one another such that the user devices 345 can display a continuous user interface (e.g., a single user interface) across the user devices 345. In some embodiments, the user devices 345 can display, present, and/or otherwise provide a plurality of user interfaces and the plurality of user interfaces can be provided across one or more given user devices 345. The user devices 345 can also be and/or include at least one of a mobile computing device, a desktop computer, a smartphone, a tablet, a smart watch, a smart sensor, and/or any other device that can facilitate providing, receiving, displaying and/or otherwise interacting with content (e.g., webpages, mobile applications, etc.).

In some embodiments, the data sources 350 can be and/or include at least one of the various data sources described herein. For example, the data sources 350 can include the system manager 202. As another example, the data sources 350 can include one or more building subsystems. For example, the data sources 350 may include at least one of electrical subsystems, information communication technology (ICT) subsystems, security subsystems, HVAC subsystems, lighting subsystems, lift/escalators subsystems, and/or fire safety subsystems. The building subsystems may include equipment and/or devices such as, economizers, field controllers, supervisory controllers, actuators, temperature sensors, light fixtures, ballasts, lighting sensors, dimmers, occupancy sensors, video surveillance cameras, digital video recorders, video processing servers, intrusion detection devices, access control devices, and servers. The data sources 350 can include lightweight data-driven models that generate the parameters used in optimization formulation and/or operational planning. The data sources 350 can also include historical data that the data-driven models can be fit to. In some embodiments, the data sources 350 can include at least one device connected to and/or in communication with the equipment 335. For example, the data sources 350 may include network automation engines, field equipment controllers, input/output modules, switches, gateways, network hubs, bridge devices, and/or edge devices.

In some embodiments, the equipment 335 can be and/or include components or pieces of building equipment. Equipment 335 can include, but is not limited to, for example, a HVAC system, heaters, chillers, boilers, air handling units, sensors, actuators, refrigeration systems, fans, blowers, heat exchangers, energy storage devices, condensers, valves, or various combinations thereof. Equipment 335 can operate in accordance with various qualitative and quantitative parameters, variables, setpoints, and/or thresholds or other criteria, for example. In some embodiments, equipment 335 can include or be coupled with one or more controllers for controlling parameters of the equipment 335, such as to receive commands for controlling operation of the equipment 335 via one or more wired, wireless, and/or user interfaces of the controller. Equipment 335 may include or be coupled with components of a building management system (BMS).

In some embodiments, the cloud system 340 can be and/or include at least one of a computing device, a remote server, a server bank, a remote device, and/or among other possible computer hardware and/or computer software. For example, the cloud system 340 can include a server bank and the server bank can store, keep, maintain, and/or otherwise hold the various types of information described herein. In some embodiments, the cloud system 340 may house and/or otherwise implement at least one of the various systems, devices, and/or components described herein. For example, the cloud system 340 can house the onboarding manager 305. As another example, the onboarding manager 305 may be distributed across one or more servers (e.g., the cloud system 340).

In some embodiments, the onboarding manager 305 can include at least one processing circuit 310 and at least one interface 325. The processing circuit 310 can include at least one processor 315 and memory 320. The processing circuit 310 and/or a component thereof (e.g., the processors 315 and memory 320) can perform similar functionality to that of the onboarding manager 305. For example, memory 320 can store programming logic that, when executed by the processors 315, cause the processors 315 to perform functionality similar to that of the onboarding manager 305. In some embodiments, the processors 315 may be implemented as a general-purpose processor, an application specific integrated circuit (ASIC), one or more field programmable gate arrays (FPGAs), a group of processing components, or other suitable electronic processing components. In some embodiments, memory 320 (e.g., memory, memory unit, memory devices, storage device, etc.) may include one or more devices (e.g., RAM, ROM, Flash memory, hard disk storage, etc.) for storing data and/or computer code for completing or facilitating the various processes, layers and modules described in the present application. Memory 320 may be or include volatile memory or non-volatile memory. Memory 320 may include one or more non-transitory storage media or medium. Memory 320 may include database components, object code components, script components, or any other type of information structure for supporting the various activities and information structures described in the present application.

In some embodiments, the interface 325 can be and/or include at least one of network communication devices, network interfaces, and/or other possible communication interfaces. The interface 325 can be and/or include wired or wireless communications interfaces (e.g., jacks, antennas, transmitters, receivers, transceivers, wire terminals, etc.) for conducting data communications with various systems, devices, and/or components described herein. The interface 325 can be direct (e.g., local wired or wireless communications) and/or via a communications network (e.g., the network 330). For example, the interface 325 can include an Ethernet card and port for sending and receiving data via an Ethernet-based communications link or network. The interface 325 can also include a Wi-Fi transceiver for communicating via a wireless communications network (e.g., the network 330). The interface 325 can include a power line communications interface. The interface 325 can include an Ethernet interface, a USB interface, a serial communications interface, and/or a parallel communications interface.

In some embodiments, the processing circuit 310 may generate, present, display, and/or otherwise provide one or more user interfaces. For example, the processing circuit 310 may transmit one or more signals to the user devices 345 to cause the user devices 345 to display a user interface. As another example, the processing circuit 310 may transmit one or more signals to provide information for display via a user interface. In some embodiments, the processing circuits 310 may display a user interface that includes information that corresponds to a building. For example, the processing circuit 310 may display a user interface that identifies equipment located at the building 10.

In some embodiments, the processing circuit 310 may receive one or more selections. For example, the processing circuit 310 may receive a selection of a building via a user interface. As another example, the processing circuit 310 may receive information that indicates and/or corresponds to a selection within a user interface. In some embodiments, the processing circuit 310 may receive the selections responsive to one or more interactions with the user interface. For example, the processing circuit 310 may receive the selection of a building responsive to an operator of the user device 345 selecting an icon associated with the building within the user interface. As another example, the processing circuit 310 may receive the selection of a building responsive to the operator of the user device 345 providing a prompt (e.g., a message, a natural language statement, etc.) to the user interface.

In some embodiments, the processing circuit 310 may update the user interface in accordance with the selection of the building. For example, the processing circuit 310 may update the user interface to display information associated with the selected building. As another example, the processing circuit 310 may update the user interface to include a list of equipment located at the building.

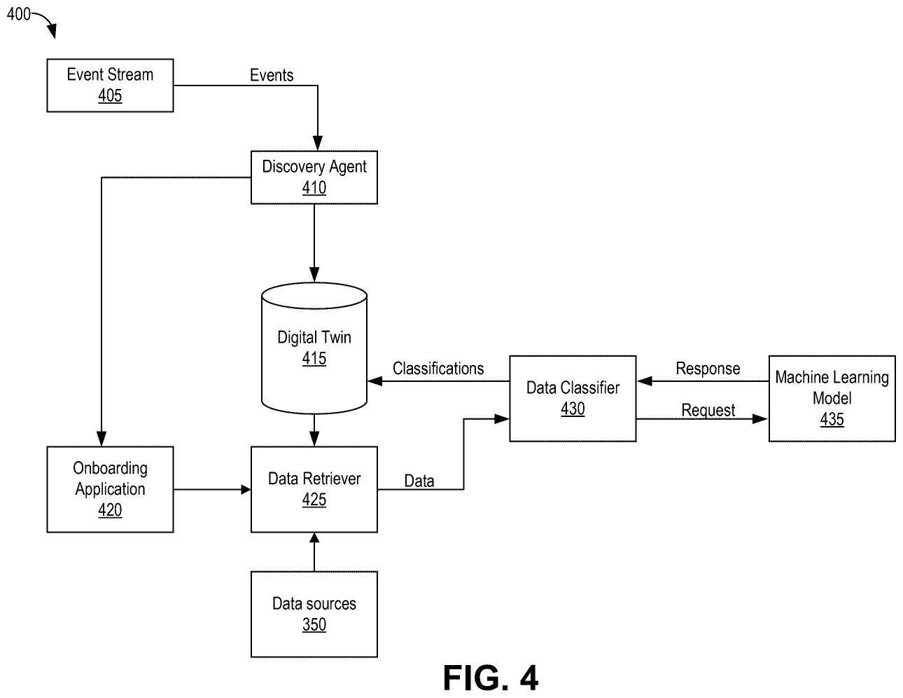

FIG. 4 is a data flow chart illustrating communication between one or more components of a system architecture 400, according to some embodiments. In some embodiments, the system architecture 400 may include and/or be implemented by one or more systems, devices, and/or components described herein. For example, the onboarding manager 305 may implement the system architecture 400. As another example, the onboarding manager 305 may include one or more systems, devices, and/or components included in the system architecture. In some embodiments, the systems, devices, and/or components of the system architecture 400 may be implemented as one or more applications, computer programs, application software, set of instructions, and/or executable code that causes a computing device to perform one or more actions and/or operations. For example, memory 320 may store executable code that when executed, by the processors 315, cause the processors 315 to perform the actions of the components shown in the system architecture 400.

As shown in FIG. 4, the system architecture 400 includes an event stream 405, a discovery agent 410, a digital twin 415, an onboarding application 420, a data retriever 425, a data classifier 430, a machine learning (shown as ML model 435), and the data sources 350. In some embodiments, one or more systems, devices, and/or components of the system architecture 400 may be stored as instructions in memory 320 such that execution of the instructions, by the processors 315, cause the processors 315 to perform the operations described herein. For example, memory 320 may store instructions that, when executed by the processors 315, cause the processors 315 to perform the operations of the discovery agent 410 as described herein.

In some embodiments, one or more systems, devices, and/or components described herein may access and/or utilize the ML model 435. For example, the ML model 435 may be stored in memory 320 and the processors 315 may access the ML model 435 from memory 320 to have the ML Model 435 perform one or more operations. As another example, the ML model 435 may be accessible via one or more application programming interface (API) calls. In this example, the ML Model 435 may receive one or more prompts that cause the ML model 435 to perform one or more operations.

In some embodiments, the ML model 435 may be trained using one or more various ML and/or Artificial Intelligence (AI) techniques. For example, the ML model 435 may be trained using supervised and/or unsupervised learning. In some embodiments, the ML model 435 is trained to generate, predict, or determine one or more classifications and/or descriptions of equipment and/or datapoints associated with the equipment. For example, the ML model 435 is trained to generate classification of the equipment 335. In some embodiments, the ML model 435 may be or include regression trees, deep neural networks, nearest neighbor-based models, supervised learning-based models, unsupervised learning-based models, Bayesian models, generative AI models such as transformer (e.g., generative pretrained transformer (GPT)) models or generative adversarial network (GAN) models or other large language models (LLMs), and/or other types of models.

In some embodiments, the ML model 435 may be trained to generate one or more standardized names for building equipment and/or datapoints based on one or more unstructured data names or one or more unstructured object names provided as inputs to the ML model 435. For example, the ML model 435 may be trained to generate classifications (e.g., standardized names, standardized object names, etc.) based on naming data (e.g., native reference, device ID, etc.) captured during device discovery or datapoint discovery. As another example, the ML model 435 may be trained to generate classifications based on building automation and control network (BACnet) object names for building devices.

In some embodiments, the ML model 435 may be trained to generate probabilities (e.g., output probabilities) for each standardized object name. The probabilities may include a vector, with each value in the vector corresponding to a respective probability value (and a corresponding standardized object name of a set of standardized names). In some embodiments, the ML model 435 may select one or more standardized names (as classifications) based on the probabilities. For example, the ML model 435 may select at least one standardized object name associated with the greatest probability of the output probabilities as the classification for the device, datapoint, and/or piece of equipment.

In some embodiments, the ML model 435 may be trained to output standardized names or tags (classifications) in a format conforming to at least one of Brick, Haystack, or OpenBlue Data Model (OBDM) schemas. In some embodiments, the ML model 435 may be trained to generate one or more tags for various pieces of equipment and/or datapoints. The ML model 435 may further be trained to generate standardized names for one or more pieces of building equipment such that the one or more pieces of building equipment may be automatically configured and/or integrated into a BMS. In some embodiments, the ML model 435 may include one or more models and/or may be trained using one or more techniques as described in U.S. patent application Ser. No. 18/436,799, filed Feb. 8, 2024, the entirety of which is incorporated by reference herein.

In some embodiments, the event stream 405 may provide one or more events to the discovery agent 410. For example, the event stream 405 may monitor interactions with user interfaces. To continue this example, the event stream 405 may forward information associated with the interactions to the discovery agent 410. As another example, the event stream 405 may be a probe device that is scanning a network to detect when new devices and/or equipment are added to network.

In some embodiments, the discovery agent 410 may retrieve one or more sets of data based on events provided by the event stream 405. For example, the discovery agent 410 may retrieve a first set of data that indicates at least one of equipment and/or datapoints associated with the equipment. To continue this example, the discovery agent 410 may retrieve the first set of data from a virtual representation of a building. In some embodiments, the virtual representation of the building may include the digital twin 415. While some examples have been described herein as retrieving and/or ingesting information into a digital twin, these examples are for illustrative purposes only and are in no way limiting. For example, information may be retrieved and/or ingested in several various databases such as, building graphs, entity graphs, and/or digital representations of information associated with a building.

In some embodiments, the discovery agent 410 may update one or more user interfaces. For example, the discovery agent 410 may update a user interface by causing the user interface to display the first set of data that was retrieved from the virtual representation of the building. As another example, the discovery agent 410 may transmit one or more signals to cause the user devices 345 to display the first set of data.

In some embodiments, the discovery agent 410 may receive a selection to search a network of a building. For example, the discovery agent 410 may receive one or more events from the event stream 405 that indicate a selection of an icon within a user interface. As another example, the discovery agent 410 may receive one or more events from the event stream 405 that indicate a natural language prompt provided to the user device 345. In some embodiments, the selection to search the network of the building may include a prompt to search the network for one or more pieces of equipment. For example, the selection may indicate a prompt to search a network of a BMS for equipment.

In some embodiments, the discovery agent 410 may discover one or more pieces of building equipment. For example, the discovery agent 410 may discover equipment 335 that was previously added to and/or connected to a BMS. As another example, the discovery agent 410 may query the digital twin 415 to search for equipment that has connected to the network.

In some embodiments, the discovery agent 410 may forward and/or otherwise provide information associated with the discovered equipment to the onboarding application 420. For example, as the discovery agent 410 discovers equipment on the network, the discovery agent 410 may forward information associated with the equipment to the onboarding application 420. In some embodiments, the onboarding application 420 may update the user interface to display one or more graphical representations. For example, the onboarding application 420 may update the user interface to indicate the discovered equipment and/or one or more datapoints associated with the discovered equipment. As another example, the onboarding application 420 may update the user interface to include elements that represent the discovered equipment.

In some embodiments, the onboarding application 420 may display information provided by and/or retrieved by the data retriever. For example, the onboarding application 420 may prompt the data retriever 425 to retrieve information from the digital twin 415. As another example, the onboarding application 420 may prompt the data retriever 425 for information provided by the data sources 350. In some embodiments, the onboarding application 420 update the user interface to include the information retrieved by the data retriever 425.

In some embodiments, the data retriever 425 may identify and/or otherwise detect unclassified and/or unmapped equipment and/or datapoints. For example, the data retriever 425 may identify that a discovered device has been added to the network but that the discovered device has not been associated with a given space of the building (e.g., no classification, no mapping, etc.). As another example, the data retriever 425 may detect that one or more datapoints associated with a discovered device have not been classified (e.g., what information is indicated by the datapoints, etc.).

In some embodiments, the data retriever 425 may provide unclassified equipment and/or unclassified datapoints to the data classifier 430. For example, the data retriever 425 may flag unclassified data (e.g., unclassified equipment, unclassified datapoints, etc.) to provide an indication to the data classifier 430. As another example, the data retriever 425 may forward unclassified equipment subsequent to the data retriever 425 detecting the unclassified equipment.

In some embodiments, the data classifier 430 may provide one or more prompts (e.g., requests) to the ML model 435. For example, the data classifier 430 may provide a prompt to the ML model 435 to have the ML model 435 generate classifications for unclassified equipment and/or unclassified datapoints. In some embodiments, the data classifier 430 may provide the ML model 435 with one or more data stings that represent the unclassified equipment and/or the unclassified datapoints. For example, the data classifier 430 may provide data strings that are native to the BMS for which the unclassified equipment was connected to. As another example, the data classifier 430 may provide one or more data strings, that were retrieved from the digital twin 415, to the ML model 435.

In some embodiments, the ML model 435 may generate one or more classifications based on the prompts provided by the data classifier 430. For example, the ML model 435 may generate classifications that describe a given piece of unclassified equipment. In this example, the classifications may indicate a type of equipment (e.g., an AHU, a VAV, a boiler, etc.). As another example, the ML model 435 may generate classification that describe a given unclassified datapoint. In this example, the classification may indicate a data type (e.g., temperature reading, equipment setpoint, operating parameter, sensor measurement, etc.).

In some embodiments, the ML model 435 may provide the classifications to the data classifier 430. For example, the ML model 435 may return the data strings as well as a description (e.g., classification) of the data strings to the data classifier 430. In some embodiments, the data classifier 430 may present the classifications via the user interface. For example, the data classifier 430 may update the user interface to present and/or otherwise include the classifications.

In some embodiments, the ML model 435 may implement and/or perform statistical analysis and/or output verification to generate one or more scores and/or values that indicate a confidence score for a given classification. For example, the ML model 435 may generate a confidence score for a given datapoint classification. To continue this example, the confidence score may indicate a likelihood that the datapoint classification properly describes (e.g., classifies) the datapoints. In some embodiments, the ML model 435 may flag or otherwise indicate one or more classifications that have confidence scores below a given threshold. For example, the ML model 435 may provide, to the data classifier 430, an indication of one or more classifications that are below the threshold. As another example, the ML model 435 may provide the inputs (e.g., data strings, unclassified equipment, unclassified datapoints, etc.) to the user device 345 for subsequent review. To continue this example, the ML model 435 may provide an indication for an operator of the user device 345 to review the classifications relative to the inputs to identify an accuracy of the classifications.

In some embodiments, the ML Model 435 may receive one or more responses from the user device 545. For example, the ML model 435 may receive verification regarding the accuracy of the classifications. As another example, the ML model 435 may receive a user defined and/or user created classification that represents the correct and/or accurate classification based on the inputs. In some embodiments, the ML model 435 may be retrained and/or reinforced based on the inputs from the user device 545. For example, one or more penalties may be applied to adjust constraints and/or weights of the ML model 435. To continue this example, the data classifier 430 may adjust the constraints to account for the penalties such that subsequent outputs (e.g., classifications) reflect the inputs received from the user device 545.

In some embodiments, the data classifier 430 may receive one or more indications of an acceptance of the classifications. For example, the event stream 405 may receive events that indicate selections of one or more icons to accept the classifications. To continue this example, the event stream 405 may forward the events to the data classifier 430. In some embodiments, the data classifier 430 may store the classifications in the virtual representation of the building. For example, the data classifier 430 may provide the classifications to the digital twin 415 to cause the digital twin 415 to ingest (e.g., store) the classifications. As another example, the data classifier 430 may transmit one or more write requests to the digital twin 415 to cause the digital twin 415 to store the classifications.

In some embodiments, the processing circuit 310 may integrate one or more pieces of building equipment without subsequent selections of a building. For example, the processing circuit 310 may present a user interface that includes and/or lists one or more buildings and/or locations. To continue this example, the processing circuit 310 may limit subsequent interactions or subsequent actions (e.g., device integration, point classifications, etc.) to a selected building such that each subsequent action can be associated with the selected building with selecting the building. Stated otherwise, once a building is selected, the processing circuit 310 may limit and/or restrict actions to the building.

In some embodiments, the processing circuit 310 may query the digital twin 415. For example, the processing circuit 310 may query the digital twin 415 to discover pieces of equipment and/or datapoints associated with the pieces of equipment. As another example, the processing circuit 310 may limit the query to pieces of equipment that were not previously detected.

In some embodiments, the processing circuit 310 may detect, responsive to query the digital twin 415, one or more changes with respect to the building. For example, the processing circuit 310 may detect an addition of a piece of building equipment (e.g., a piece of equipment was installed at the building, a piece of equipment was added to the BMS, a piece of equipment was connected to a communications network, etc.). As another example, the processing circuit 310 may detect a removal of piece of equipment from the building (e.g., decommissioned, replaced, legacy, etc.). As even another example, the processing circuit 310 may detect an adjustment to a classification between one or more datapoints and/or one or more pieces of building equipment.

In some embodiments, the processing circuit 310 may prompt the ML model 435 to generate one or more mappings to reflect the changes. For example, the processing circuit 310 may prompt the ML model 435 to generate a mapping for a piece of equipment that was added to the building (e.g., where the equipment is located in the building, what areas the equipment services, etc.). As another example, the processing circuit 310 may prompt the ML model 435 to generate a mapping that replaces a removed piece of equipment with the equipment's replacement (e.g., new equipment).

### System Workflow and User Experience (UX)

As described herein, one or more systems, devices, and/or components may generate, present, display, and/or otherwise provide at least one user interface. The user interfaces may be presented via one or more display devices (e.g., monitors, screens, etc.) to present information associated with a building. In some embodiments, the user interfaces may be presented as a single continuous user interface that is updated to included additional information. In other embodiments, a first user interface may be replaced with a second user interface such that that second user interface display information not shown in the first user interface. In other examples, the user interfaces may be presented as one or more overlays and/or pop-up windows.

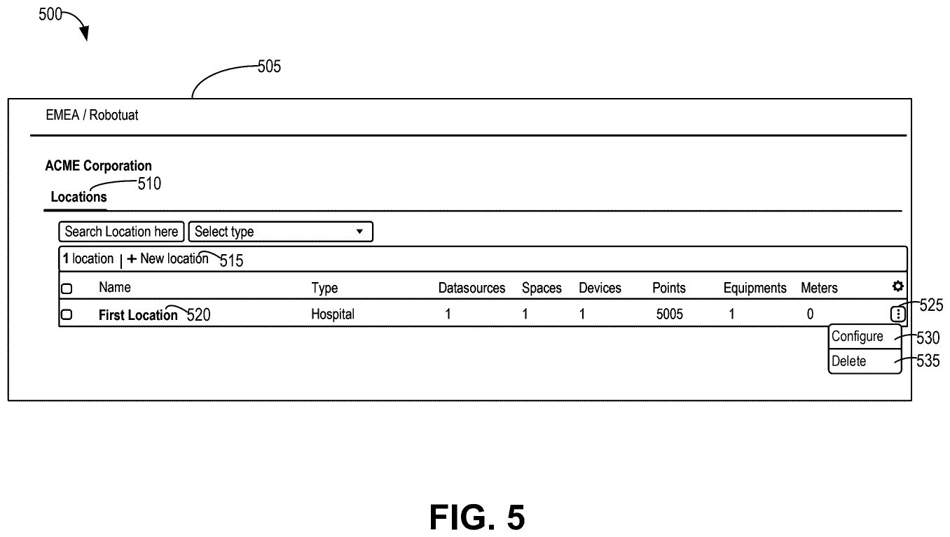

FIG. 5 depicts a user interface 500, according to some embodiments. In some embodiments, the user interface 500 may represent a building view and/or site view. For example, the user interface 500 may present information associated with a given building. As shown in FIG. 5, the user interface 500 includes window 505 that presents information associated with locations 510. In some embodiments, the locations 510 may be provided as a tab or other selectable element such that selection of the locations 510 causes the information shown in FIG. 5 to be presented by a display device. As shown in FIG. 5, the user interface 500 includes a first location 520 which is shown to include a given type, a given number of data sources, a given number of spaces, a given number of points, a given number of equipment, and a given number of meters. Accordingly, the user interface 500 is shown to present information at a building level.

In some embodiments, selection of new location 515 may cause a pop-up window or other possible data input element to be displayed such that information may be entered to create a new location. For example, an operator of the display device that is presenting the user interface 500 may select on the new location 515 to cause the user interface 500 to include a pop-up window. As shown in FIG. 5, the user interface 500 includes settings 525, which is shown to include configure 530 and delete 535. In some embodiments, the configure 530 and the delete 535 may be presented responsive to interfacing with the settings 525. For example, placing a cursor on top or next to the settings 525 may cause the configure 530 and the delete 535 to be presented. As another example, a selection of the settings 525 may cause the configure 530 and the delete 535 to be presented.

In some embodiments, the processing circuit 310 may receive a selection of a building based on the selection of the first location 520. For example, the processing circuit 310 may receive one or more signals responsive to the selection of the first location 520. In some embodiments, the processing circuit 310 may retrieve one or more sets of data based on the selection. For example, the processing circuit 310 may retrieve information from the digital twin 415 that corresponds to the first location 520. As another example, the processing circuit 310 may transmit one or more API calls to retrieve information from one or more databases.

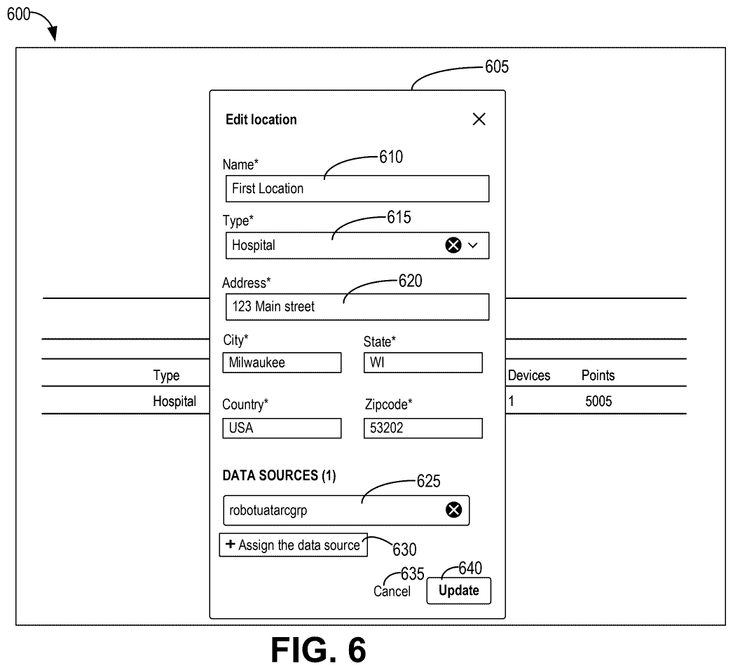

FIG. 6 depicts a user interface 600, according to some embodiments. In some embodiments, the user interface 600 may be presented as a pop-up window and/or an overly on top of the user interface 500. For example, the user interface 600 may be presented on top of the user interface 500 responsive to a selection of the configure 530. As shown in FIG. 6, the user interface 600 includes window 605 which is shown to include input elements 610, 615, 620, 625, 630, 635, and 640. In some embodiments, information may be provided to the input element 610 to update and/or otherwise change a name of the first location 520. For example, an operator of a device displaying the user interface 600 may edit, update, revise, and/or change the name of the first location 520 via the input element 610.

In some embodiments, the operator of the device displaying the user interface 600 may change a type (e.g., hospital, school, commercial, residential, mixed-use, etc.) of the building by interfacing with the input element 615. The operator of the device displaying the user interface 600 may change address information associated with the first location 520 by interfacing with the input element 620. In some embodiments, the operator of the device displaying the user interface 600 may select one or more data sources via the input elements 625 and 630. The operator of the device displaying the user interface 600 may cancel and/or update one or more changes provided via the window 605 by selecting the input element 635 and/or the input element 640.

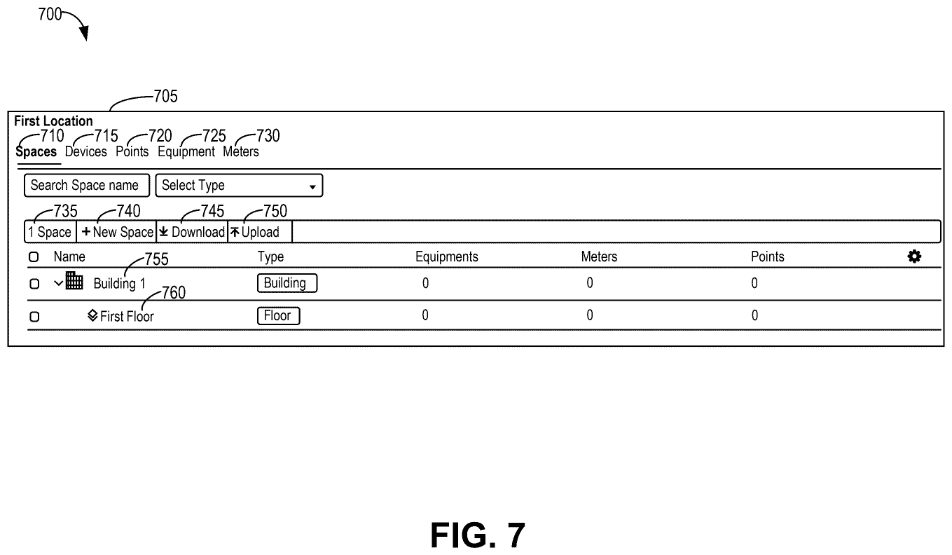

FIG. 7 depicts a user interface 700, according to some embodiments. In some embodiments, the user interface 700 may represent a space view. For example, the user interface 700 may display and/or include information that is specific to one or more spaces of the building. Stated otherwise, the user interface 700 may display information that corresponds to given space of the building. In some embodiments, the user interface 700 may be displayed and/or responsive to selection of the first location 520 in the user interface 500.

In some embodiments, the user interface 700 provides tools to create, adjust, and/or modify a spatial hierarchy of at least one building associated with a site (e.g., location) while also ensuring that any changes adhere to spatial hierarchy rules. Additionally, the user interface 700 may provide tools such that a user may drag and drop any space between and within buildings without having to edit every item. As another example, the user interface 700 may provide tools such that a user may upload and/or otherwise provide spatial hierarchy information in bulk from within the user interface 700. As another example, the user interface 700 may provide tools such that information that corresponds to the spaces of the building may be pushed to one or more remote sources (e.g., the cloud system 340, remote databases, etc.).

As shown in FIG. 7, the user interface 700 includes tabs 710, 715, 720, 725, and 730. The tab 710 is shown to correspond to spaces (e.g., space view). The tab 715 is shown to correspond to devices (e.g., device view). The tab 720 is shown to correspond to points (e.g., points view). The tab 725 is shown to correspond to equipment (e.g., equipment view). The tab 730 is shown to correspond to meters (e.g., meters view).

In some embodiments, the user interface 700 may include a window 705 that presents information associated with a selected tab (e.g., tabs 710, 715, 720, 725, 730, etc.). As shown in FIG. 7, the tab 710 has been selected. In some embodiments, the user interface 700 may display or include a spatial hierarchy of the building. For example, as shown in FIG. 7, the user interface 700 is shown to include building 755 which is shown to include floor 760. Additionally, the floor 760 is shown indented relative to the building 755 to illustrate that the floor 760 is a sub-level off of the building 755.

In some embodiments, the user interface 700 includes elements 735, 740, 745, and 750. As shown in FIG. 7, the element 735 is shown to indicate a number of spaces included in the building 755. Moreover, the element 740 is shown as a selectable (e.g., button) element to add a new space to the building 755. Additionally, elements 745 and 750 are shown to be associated with data retrieval and data submission (e.g., download, upload, etc.). In some embodiments, selection of at least one of the elements 735, 740, 745, and/or 750 may cause the user interface 700 to be updated and/or replaced. For example, selection of the element 740 may cause a pop-up window to be presented and/or overlayed on top of the user interface 700.

In some embodiments, the user interface 700 may include drag and drop functionality such that spaces may be moved from a first area to a second area. For example, a room (e.g., a space) may be moved from a first floor to a second floor by selecting the room and dragging the room to the second floor (within the user interface 700).

In some embodiments, the processing circuit 310 may receive a selection to display a spatial hierarchy. For example, the processing circuit 310 may receive an indication from the user device 345 of a selection of the tab 710. As another example, the processing circuit 310 may detect selection of the tab 710. In some embodiments, the processing circuit 310 may identify a building and/or location associated with the selection. For example, the processing circuit 310 may identify a given site and/or location selected prior to the selection to display the spatial hierarchy.

In some embodiments, the processing circuit 310 may retrieve one or more sets of data that represent the spatial hierarchy. For example, the processing circuit 310 may query the digital twin 415 to retrieve information that indicates one or more floors (e.g., spaces) of the building. As another example, the processing circuit 310 may retrieve one or more sets of data from the data sources 350 which indicate the spatial hierarchy of the building.

In some embodiments, the processing circuit 310 may display a graphical representation of the spatial hierarchy. For example, the processing circuit 310 may cause the user interface 700 to be displayed. As another example, the processing circuit 310 may cause a user interface to display the floor 760 as an off shoot or sub level of the building 755. In some embodiments, the processing circuit 310 may receive an input to add a space to the spatial hierarchy. For example, the processing circuit 310 may detect selection of the element 740. As another example, the processing circuit 310 may receive a prompt to add a space to the spatial hierarchy.

In some embodiments, the processing circuit 310 may update the user interface to include one or more elements to add the space. For example, the processing circuit 310 may update the user interface to include the input elements of the user interface 700. As another example, the processing circuit 310 may prompt the user device 345 to provide an indication of where to add the space.

In some embodiments, the processing circuit 310 may update the spatial hierarchy by ingesting the new space into the digital twin 415. As another example, the processing circuit 310 may update the spatial hierarchy by adding the new space to a data structure that represents the spatial hierarchy. In some embodiments, the processing circuit 310 may update the spatial hierarchy with a selection of the building. For example, the processing circuit 310 may update the spatial hierarchy illustrated in FIG. 7 without an input that specifies the first location 520. Stated otherwise, the processing circuit 310 restricts updates to the spatial hierarchy to the building for which is being presented via the user interface.

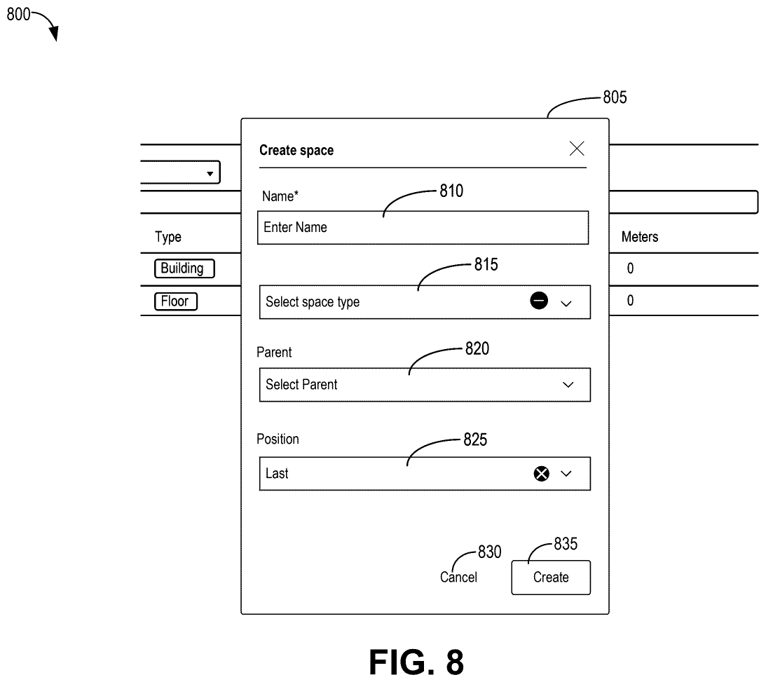

FIG. 8 depicts a user interface 800, according to some embodiments. In some embodiments, the user interface 800 may be presented and/or generated responsive to selection of the element 740. For example, the user interface 800 may be presented as an overlay on top of the user interface 700. In some embodiments, the user interface 800 may include window 805. The window 805 may include input elements 810, 815, 820, 825, 830, and 835.

As shown in FIG. 8, the element 810 may receive information to indicate a name for a new space. The element 815 may receive information to indicate a space type (e.g., floor, zone, room, etc.) for the new space. The element 820 may receive information to indicate a parent (e.g., if the space is a floor, then the parent would be the building, if the space was a zone, then the parent would a floor, etc.). The element 825 may receive information to indicate a position of the new space. The elements 830 and 835 may receive inputs to either cancel the creation of the new space and/or to create the new space.

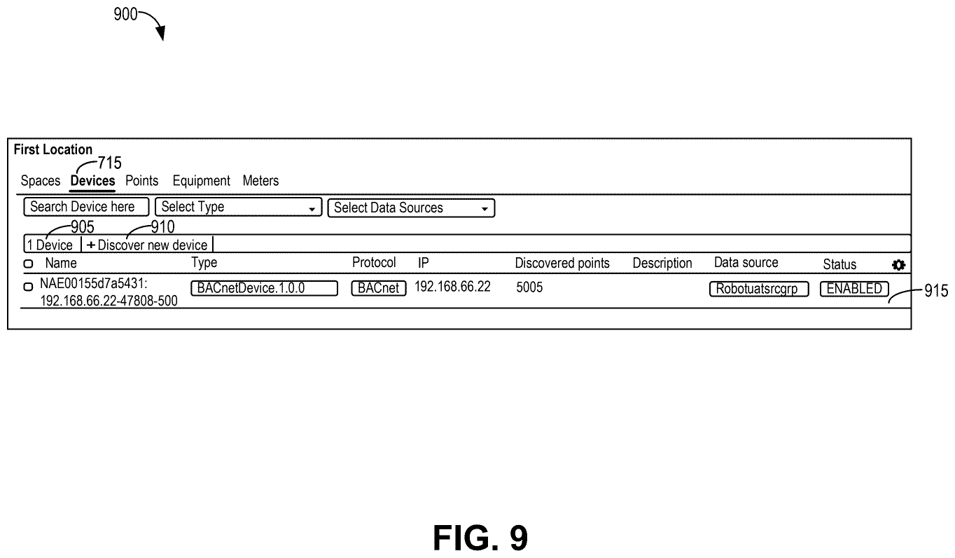

FIG. 9 depicts a user interface 900, according to some embodiments. The user interface 900 may represent a device view. For example, the user interface 900 may include information that identifies one or more devices of the building. As another example, the user interface 900 may include information that indicates the data sources 550. In some embodiments, the user interface 900 may be presented or otherwise generated responsive to selection of the tab 715. For example, selection of the tab 715 in the user interface 700 may cause the user interface 900 to be generated. In some embodiments, the user interface 900 includes one or more entries 915 to indicate the devices. For example, a first entry 915 may be associated with a first data source 350. As another example, a second entry 915 may be associated with a second data source 350.

As shown in FIG. 9, the entries 915 may include information to identify a name of the device, a device type, a protocol of the device, an IP address of the device, a number of discovered points, a data source, and a status of the device. In some embodiments, the user interface 900 may include elements 905 and 910. As shown in FIG. 9, the element 905 is shown to indicate a number of devices and the element 910 is shown as a selectable element to discover new devices.

In some embodiments, the user interface 900 may provide tools such that a user may perform single device discovery using an IP address of a single device. Additionally, the user interface 900 may include tools such that points may be grouped to various equipment and the equipment may be auto-created and/or classified by one or more models (e.g., the ML models 435). In some embodiments, the auto-creation and/or classification of the equipment may occur as a result of a single interaction with the user interface 900 and the classification of the equipment may be dispersed and/or carried through one or more levels of the spatial hierarchy.

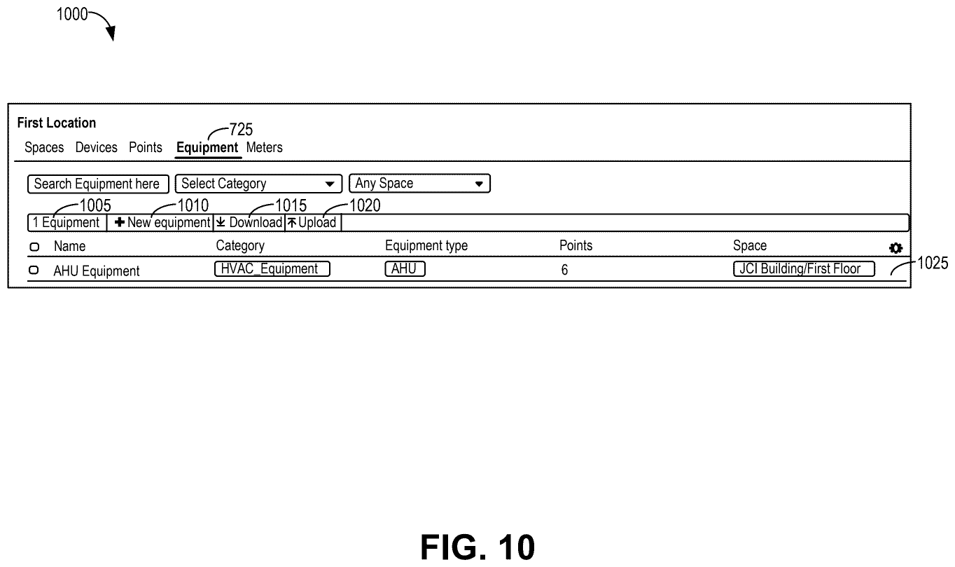

FIG. 10 depicts a user interface 1000, according to some embodiments. In some embodiments, the user interface 1000 may represent an equipment view. For example, the user interface 1000 may include information associated with one or more pieces of equipment. In some embodiments, the user interface 1000 may be presented and/or generated responsive to selection of the tab 725. As shown in FIG. 10, the user interface 1000 includes entries 1025. In some embodiments, the entries 1025 may represent and/or indicate given pieces of building equipment. For example, the entries 1025 may indicate the equipment 335.

In some embodiments, the user interface 1000 may include elements 1005, 1010, 1015, and 1020. As shown in FIG. 10, the element 1005 is shown to indicate a number of pieces of equipment. The element 1010 is shown as a selectable element to create a new piece of equipment. The elements 1015 and 1020 are shown to be associated with data retrieval and data submission (e.g., download, upload, etc.). In some embodiments, selection of the element 1010 may cause one or more overlays and/or pop-up windows to be generated. For example, a pop-up window may be displayed on top of the user interface 1000 responsive to selection of the element 1010.

In some embodiments, the processing circuit 310 may receive a selection of a piece of equipment. For example, the processing circuit 310 may detect a selection of the entry 1025. As another example, the processing circuit 310 may receive a prompt to provide information associated with the entry 1025. In some embodiments, the processing circuit 310 may update the user interface to include one or more classifications. For example, the processing circuit 310 may update the user interface 1000 to include a classification of the entry 1025 and/or a classification of one or more datapoints associated with the entry 1025.

In some embodiments, the processing circuit 310 may receive an adjustment to the classifications. For example, the processing circuit 310 may receive an adjustment to the classification of the entry 1025. To continue this example, the adjustment to the classification may include a change in the name of the entry, a change to a category type, a change to an equipment type, and/or a change to the location of the entry 1025 within the building.

In some embodiments, the processing circuit 310 may update the virtual representation of the building to reflect the adjustments. For example, the processing circuit 310 may provide one or more inputs to the digital twin 415 to adjust the classification of the entry 1025 within the digital twin 415. In some embodiments, the processing circuit 310 may update the classifications without a subsequent selection of the building. For example, the processing circuit 310 restricts the update of the classification to the building that is known to include the entry 1025. As another example, the processing circuit 310 tracks interactions with the user interface to know corresponding building for which classifications are being displayed.

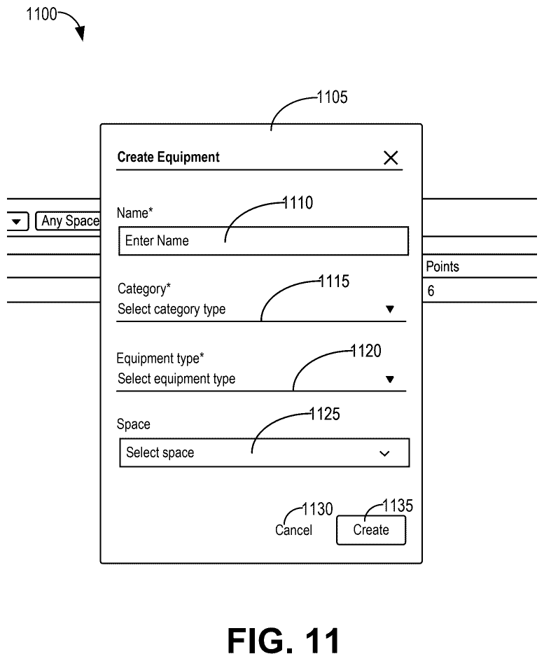

FIG. 11 depicts a user interface 1100, according to some embodiments. In some embodiments, the user interface 1100 may be generated and/or presented responsive to selection of the element 1010. For example, the user interface 1100 may be generated as an overlay on top of the user interface 1000. In some embodiments, the user interface 1100 may include a window 1105 that includes one or more elements to receive information. For example, the user interface 1100, as is illustrated in FIG. 11, includes input elements 1110, 1115, 1120, 1125, 1130, and 1135. In some embodiments, the input element 1110 may receive information to indicate a name for a new piece of equipment. The input element 1115 may receive information to indicate a category of the new piece of equipment (e.g., HVAC equipment, chiller equipment, boiler equipment, etc.). The input element 1120 may receive information to indicate an equipment type for the new piece of equipment (e.g., AHU, VAV, ventilation, etc.). The input element 1125 may receive information to indicate a space that includes and/or that is serviced by the new piece of equipment. The elements 830 and 835 may receive inputs to either cancel the creation of the new space and/or to create the new space.

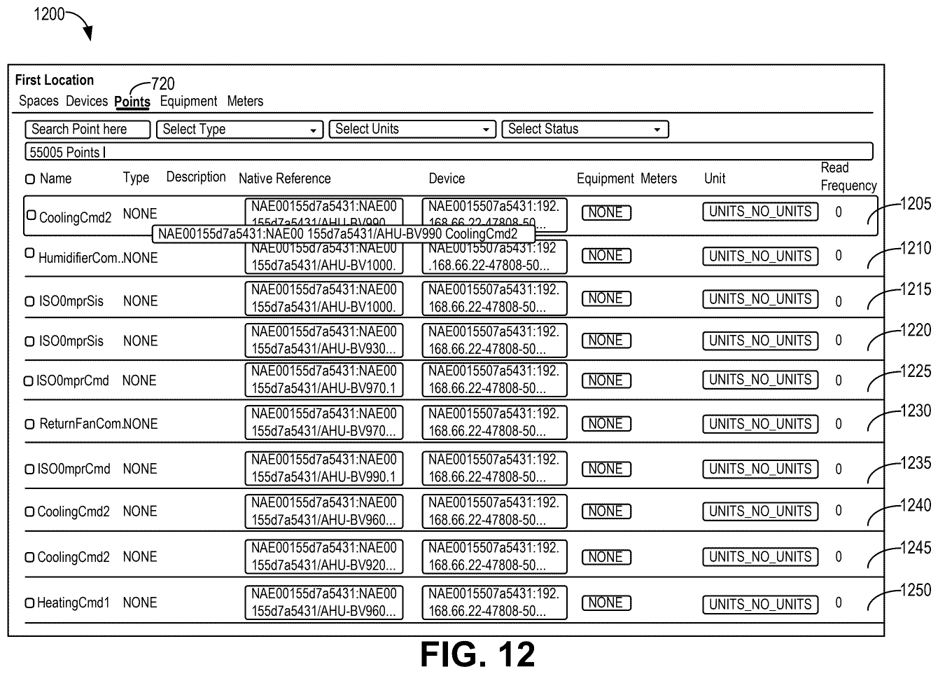

FIG. 12 depicts a user interface 1200, according to some embodiments. In some embodiments, the user interface 1200 may represent a points view. For example, the user interface 1200 may include information associated with one or more datapoints associated with the equipment illustrated in the user interface 1000. In some embodiments, the user interface 1200 may be displayed and/or generated responsive to selection of the element 910. For example, selection of the element 910 may cause the processing circuit 310 to query the digital twin 415 for one or more datapoints that were added to and/or detected on a network of the building.

In some embodiments, the user interface 1200 may provide tools such that all discovered points and/or devices (including point configurations) are shown within a single view or page. Additionally, if building systems are arranged to consider min values, max values, etc., corresponding information is auto populated against these points (e.g., min values, max values, etc.) to ensure that the points are classified appropriately.

In some embodiments, the user interface 1200 may include tools such that a user may classify points either one point at time or in bulk (e.g., multiple points all at once). Additionally, the user interface 1200 may present the points as one or more rows and each row may include a simplified user readable status message that indicates if a correspond point is configured or not. The user interface 1200 may also present information that indicates when the most recent telemetry value was received such that a user may verify if a point was correctly configured. In some embodiments, the user interface 1200 may be paginated such that multiple rows may be presented all at once. For example, the user interface 1200 may be paginated such that 100 rows (e.g., 100 entries, 100 datapoints, etc.) may be presented within the user interface 1200.

In some embodiments, the user interface 1200 may include entries 1205, 1210, 1215, 1220, 1225, 1230, 1235, 1240, 1245, and 1250. For example, the user interface 1200 may include given entries to indicate one or more discovered datapoints. In some embodiments, the entries may be associated with unclassified and/or unmapped datapoints. Stated otherwise, a description as to what the datapoint represents may not have been determined yet. In some embodiments, the entries may be selectable and/or interactive such that selection of a given entry may cause the user interface 1200 to display information associated with the selected entry. For example, selection of the entry 1205 may cause the user interface 1200 to be updated to present information associated with the entry 1205.

In some embodiments, the processing circuit 310 may receive one or more selections of graphical representations. For example, the processing circuit 310 may detect a selection of at least one entry of the user interface 1200. As another example, the processing circuit 310 may receive information from the user device 345 that indicates selection of a given entry (e.g., equipment).

In some embodiments, the processing circuit 310 may update the user interface to display one or more classifications associated with the selections. For example, the processing circuit 310 may update the user interface to include the information illustrated in FIG. 12. As another example, the processing circuit 310 may update the user interface to include a description of the selected devices, selected equipment, and/or selected datapoints. In some embodiments, the processing circuit 310 may receive one or more selections of an element to indicate acceptance of the classifications. For example, the processing circuit 310 may receive a selection of an element that indicates an acceptance of a classification of the entry 1205. As another example, the processing circuit 310 may receive one or more responses to prompts asking for acceptance of the classifications.

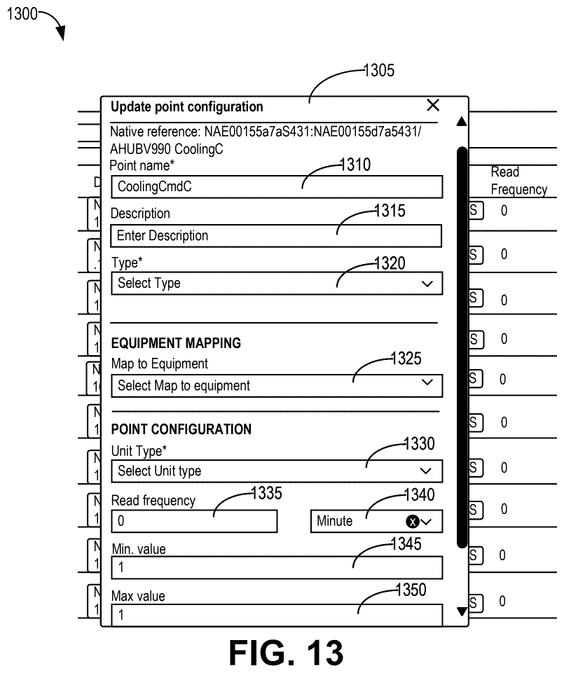

FIG. 13 depicts a user interface 1300, according to some embodiments. In some embodiments, the user interface 1300 may be generated and/or displayed responsive to a selection of a given entry included in the user interface 1200. For example, the user interface 1300 may be displayed responsive to the selection of the entry 1205. In some embodiments, the user interface 1300 may include window 1305. The window 1305 may include input elements 1310, 1315, 1320, 1325, 1330, 1335, 1340, 1345, and 1350. In some embodiments, the input elements included in the window 1305 may display and/or include information generated by the ML model 435. For example, the input elements may include classifications generated by the ML model 435. As another example, the input element may include naming conventions for one or more datapoints.

As shown in FIG. 13, the input element 1310 indicates a name for a given datapoint. The input element 1315 may receive information to indicate a description for the given datapoint. The input element 1320 may receive information to indicate a datapoint type for the given datapoint. The input element 1325 may receive information to indicate a mapping for the given datapoint to a given piece of equipment. The input element 1330 may receive information to indicate a unit type. The input elements 1335, 1340, 1345, and 1350 may receive information to indicate a frequency for which this given datapoint is polled and/or searched for.

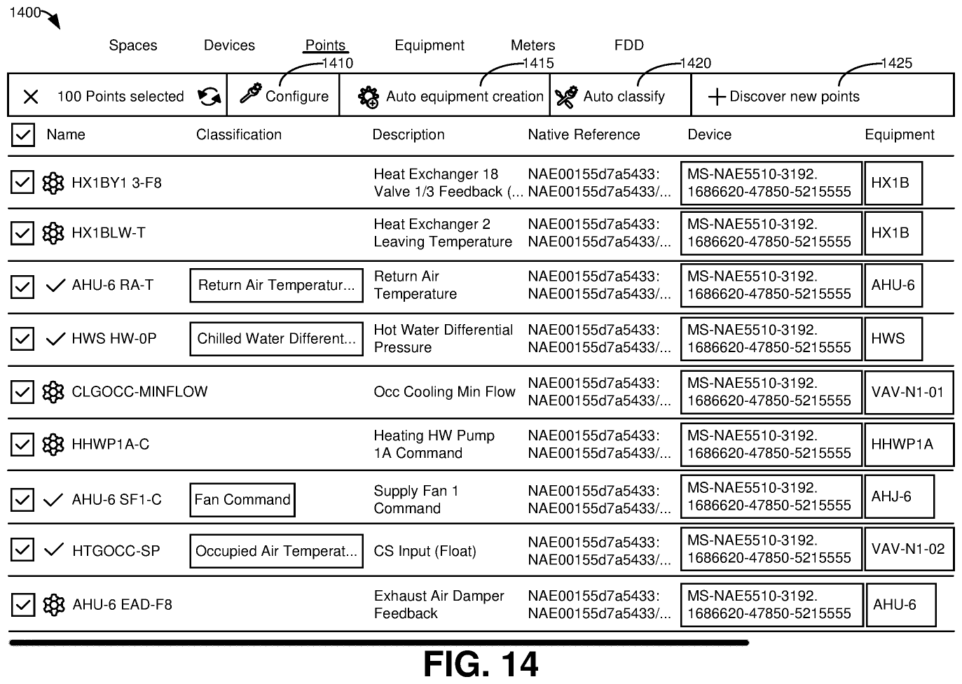

FIG. 14 depicts a user interface 1400, according to some embodiments. In some embodiments, the user interface 1400 may refer to or include a point view. For example, the user interface 1400 may present information associated with one or more datapoints published or transmitted by the data sources 350. The datapoints may be produced by or associated with operation of the equipment 335. As shown in FIG. 14, the user interface 1400 includes multiple rows and each row represents a respective datapoint detected on the network. The datapoints can be presented with one or more sets of information. For example, as shown in FIG. 14, each datapoint is shown to include corresponding information, such as name, classification, description, native reference, name of device that published datapoint, and corresponding piece of equipment that produced datapoint.

In some embodiments, the user interface 1400 can include one or more elements or input sections to receive one or more commands. For example, as shown in FIG. 14, the user interface 1400 includes element 1410, element 1415, element 1420, and element 1425. In some embodiments, selection of the element 1410 may result in the display or production of a window or user interface to configure one or more points. For example, selection of the element 1410 may produce a window to adjust a name or classification for one or more datapoints. In some embodiments, selection of the element 1415 may result in a creation of one or more pieces of building equipment. For example, selection of the element 1415 may prompt the ML model 435 to create a piece of equipment using a native reference or point name (for the selected points).

In some embodiments, selection of the element 1420 may result in one or more prompts to indicate a classification process. For example, selection of the element 1420 may produce a prompt to implement an auto-classification process which maps datapoints to previously created equipment. If no corresponding piece of equipment is identified or found, the user interface 1400 may display a prompt to create the corresponding piece of equipment. For example, selection of the prompt may trigger prompting the ML model 435 to create a piece of equipment.

In some embodiments, selection of the element 1425 may trigger searching on a network. For example, selection of the element 1425 may trigger the processing circuit 310 to search a LAN (of the building 10) for one or more published but not yet retrieve datapoints. As another example, selection of the element 1425 may trigger the processing circuit 310 to discover one or more datapoints which have been published subsequent to a previously search of the network.

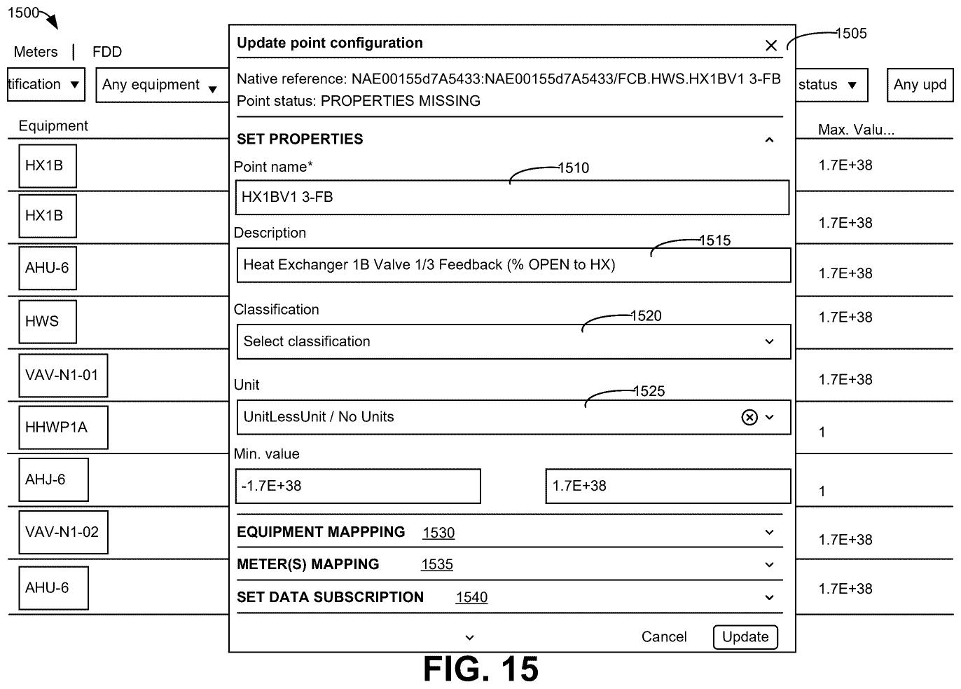

FIG. 15 depicts a user interface 1500, according to some embodiments. In some embodiments, the user interface 1500 may be presented or otherwise generated responsive to selection of the element 1410. The user interface 1500 may include a window 1505 which is presented as an overlay or pop-up window on top of the user interface 1400. In some embodiments, the user interface 1500 includes one or more elements to adjust one or more aspects of selected points. For example, as shown in FIG. 15, the user interface 1500 includes element 1510, element 1515, element 1520, element 1525, element 1530, element 1535, and element 1540. In some embodiments, interaction with a respective element of the user interface 1500 may adjust a single aspect of the selected points. For example, interaction with the element 1510 may provide the option or ability to adjust the name of a selected point. As another example, interaction with the element 1515 may provide the option or ability to adjust the description of the selected point. As another example, interaction with the element 1520 may provide the option or ability to select a classification for the selected point.

In some embodiments, interaction with the element 1530 may present an additional window or text box to select or change an equipment mapping. For example, interaction with the element 1530 may open a text box which lists a piece of equipment that the selected point is mapped to. In some embodiments, the element 1530 may provide an option to adjust the mapping (e.g., select a different piece of equipment).

In some embodiments, interaction with the element 1535 may present an additional window or text box to view a meter mapping. For example, selection of the element 1535 may present a text box which illustrates which meter the selected point corresponds to. In some embodiments, selection of the element 1540 may present an additional window or text box to view subscription information. For example, selection of the element 1540 may present a text box which illustrates how frequently the selected point may be read from or checked on the network.

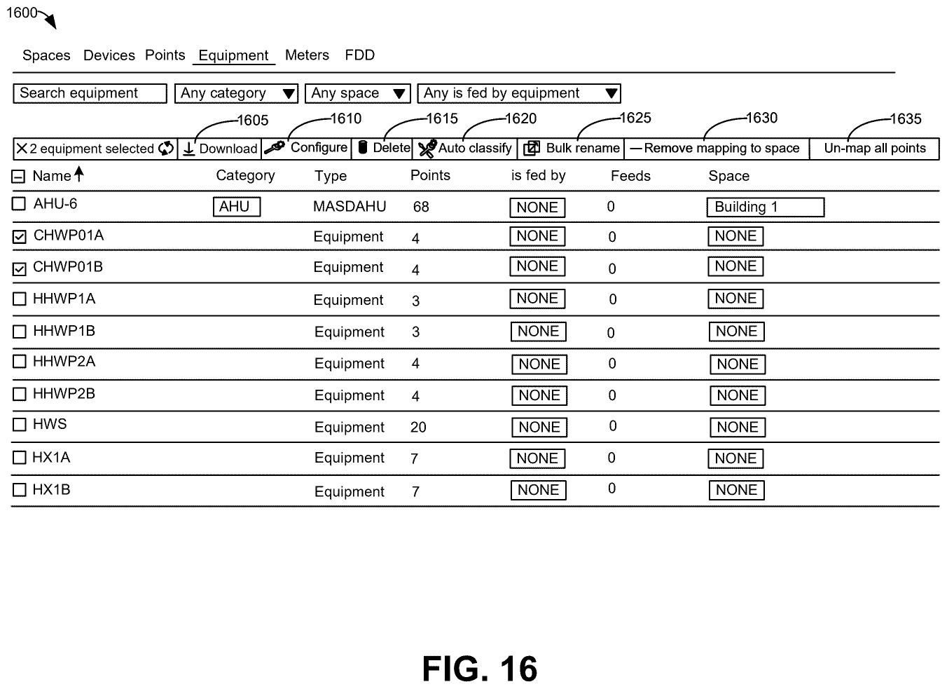

FIG. 16 depicts a user interface 1600, according to some embodiments. In some embodiments, the user interface 1600 may present information associated with one or more pieces of equipment (e.g. the equipment 335). The user interface 1600 may be presented responsive to selection of the tab 725 within one or more of the user interfaces described herein. In some embodiments, the user interface 1600 may include one or more elements to adjust one or more aspects of the displayed pieces of equipment. For example, as shown in FIG. 16, the user interface 1600 includes element 1605, element 1610, element 1615, element 1620, element 1625, element 1630, and element 1635.

In some embodiments, selection of the element 1605 may result in generation of a downloadable file which includes the information associated with the pieces of equipment. Selection of the element 1610 may result in the generation or display of a window or overlay to adjust one or more aspects of the pieces of equipment. In some embodiments, interaction with the element 1615 may result in one or more selected pieces of equipment being deleted. Interaction with the element 1620 may trigger performance of one or more of the classification techniques described herein to classify or otherwise map one or more pieces of equipment to one or more spaces within the building or one or more devices within the building.

In some embodiments, selection of the element 1625 may result in the generation or display of a window or overlay to perform a bulk renaming of one or more pieces of equipment. Selection of the element 1630 may result in removing or otherwise deleting a mapping between the selected piece of equipment and a space of the building. In some embodiments, selection of the element 1635 may result in deleting any mapping between the selected piece of equipment and one or more datapoints.

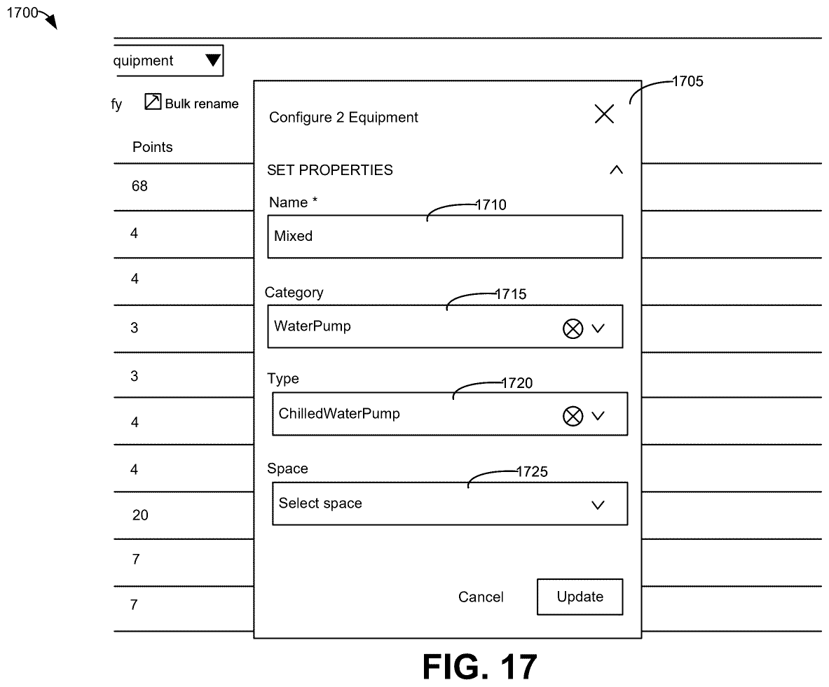

FIG. 17 depicts a user interface 1700, according to some embodiments. In some embodiments, the user interface 1700 may be presented or otherwise generated responsive to selection of the element 1610. The user interface 1800 may include one or more elements, regions, or areas to adjust one or more aspects of selected pieces of equipment. For example, as shown in FIG. 17, the user interface 1700 includes window 1705 which is shown to include element 1710, element 1715, element 1720, and element 1725. In some embodiments, interaction with one or more of the elements of the window 1705 may adjust or change one or more aspects of selected equipment. For example, element 1710 may present an option to adjust or change a name of the selected equipment. As another example, element 1715 may present an option to adjust a category for the selected equipment. Element 1720 may present an option to adjust or change an equipment type for the selected equipment. Element 1725 may present an option to adjust or change a space for which the selected equipment is located.

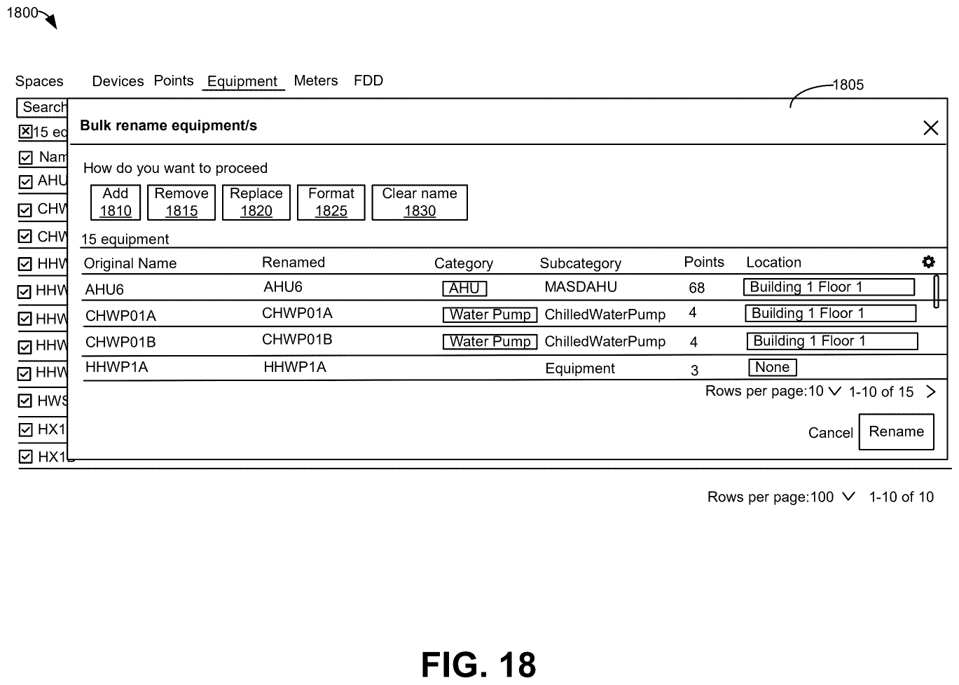

FIG. 18 depicts a user interface 1800, according to some embodiments. In some embodiments, the user interface 1800 may be presented, displayed, or otherwise generated responsive to selection of the element 1625. The user interface 1800 may present one or more options or tools to adjust a naming convention or nomenclature used for one or more selected pieces of equipment. For example, as shown in FIG. 18, the user interface 1800 includes an element to add on to a name (shown as add 1810), an element to remove from a name (shown as remove 1815), an element to replace within a name (shown as replace 1820), an element to change a format of a name (shown as format 1825), and an element to clear a name (shown as clear name 1830). In some embodiments, one or more of the elements of the user interface 1800 may be selected. For example, the add 1810 and the format 1825 may both be selected such that a subsequent window may be populated to allow for adding on to an equipment name and also being able to readjust a format of the equipment name.

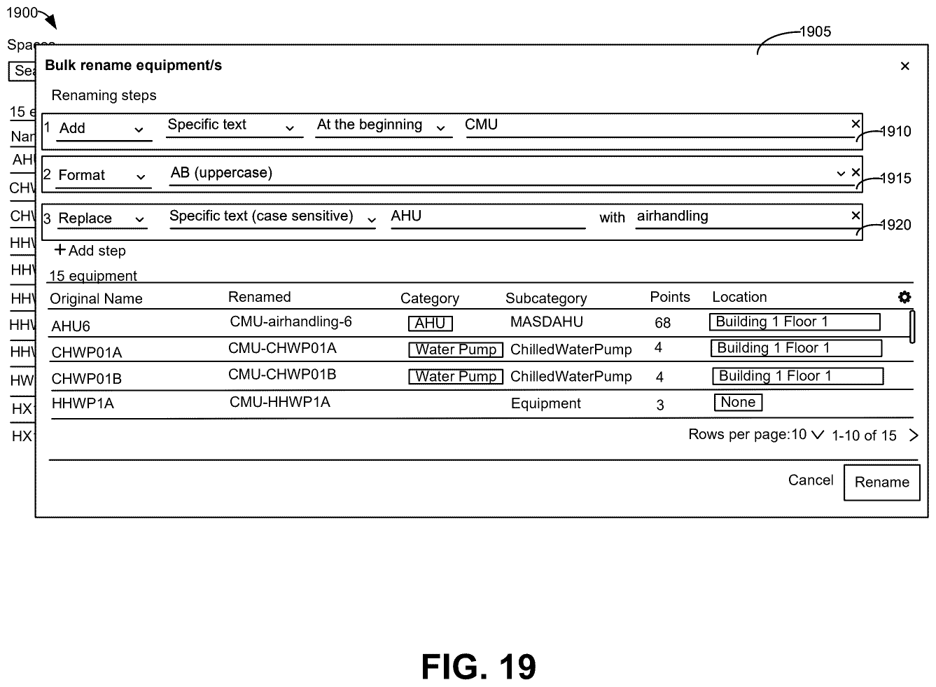

FIG. 19 depicts a user interface 1900, according to some embodiments. In some embodiments, the user interface 1900 may be generated, presented, or displayed responsive to selection of at least one of add 1810, remove 1815, replace 1820, format 1825, or clear name 1830 and a subsequent selection of rename (as shown in FIG. 18). As shown in FIG. 19, the user interface 1900 includes a window 1905 which includes one or more rows (shown as row 1910, row 1915, and row 1920) to adjust one or more aspects of the selected pieces of equipment. In some embodiments, the window 1905 can include a list of the selected pieces of equipment as well as a name prior to adjustment (e.g., original name) and a name after adjustment (e.g., renamed) for each of the selected points.

FIG. 19 depicts an example of where the row 1910 was used to add specific text (“CMU”) to the beginning of the name for each of the selected pieces of equipment, a format of the name was changed to uppercase, a string “AHU” was switched to “airhandling”. For example, as shown in FIG. 19, “AHU-6” was renamed to “CMU-airhandling-6.” In this example, “CMU” was added to the front of “AHU-6” which then made the name “CMU-AHU-6.” Furthermore, “AHU” was replaced with “airhandling” which further resulted in the name being “CMU-airhandling-6.”

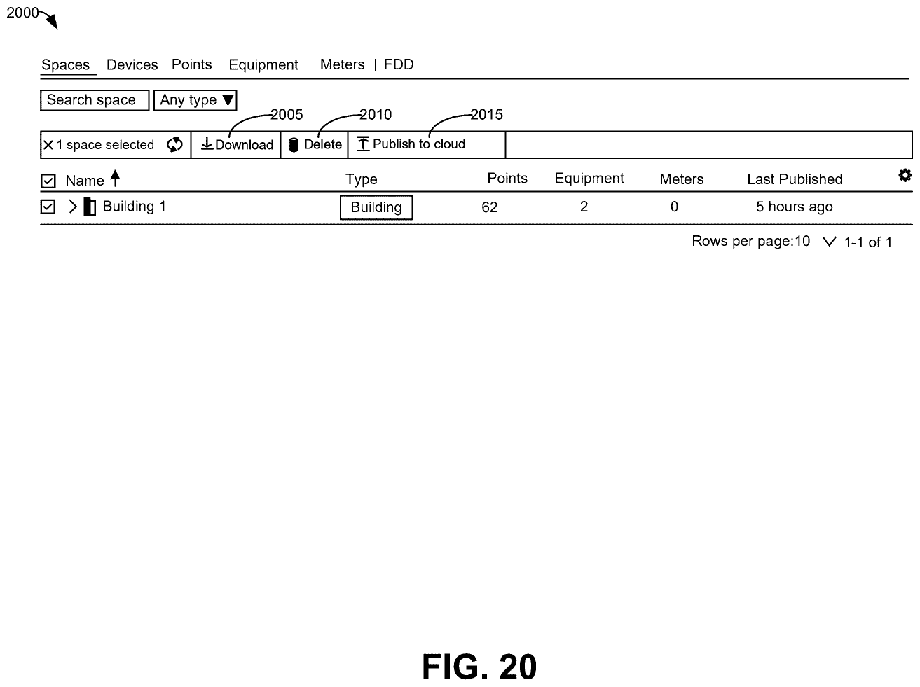

FIG. 20 depicts a user interface 2000, according to some embodiments. In some embodiments, the user interface 2000 may be presented, displayed, or generated subsequent to or responsive to classifying, mapping, or configuring one or more devices, datapoints, or pieces of equipment. For example, the user interface 2000 may be presented responsive to generating one or more mappings between equipment and spaces of the building 10. As shown in FIG. 20, the user interface 2000 includes respective entries which represent corresponding buildings or spaces within the building. In some embodiments, the user interface 2000 may include one or more elements. For example, as shown in FIG. 20, the user interface 2000 includes element 2005, element 2010, and element 2015. In some embodiments, selection of the element 2005 may result in the generation of a downloadable file which includes information associated with the selected building or space. Selection of the element 2010 may trigger the deletion or removal of one or more mappings for the selected building or space. In some embodiments, selection of the element 2015 may initiate a publishing or pushing of data to the cloud.

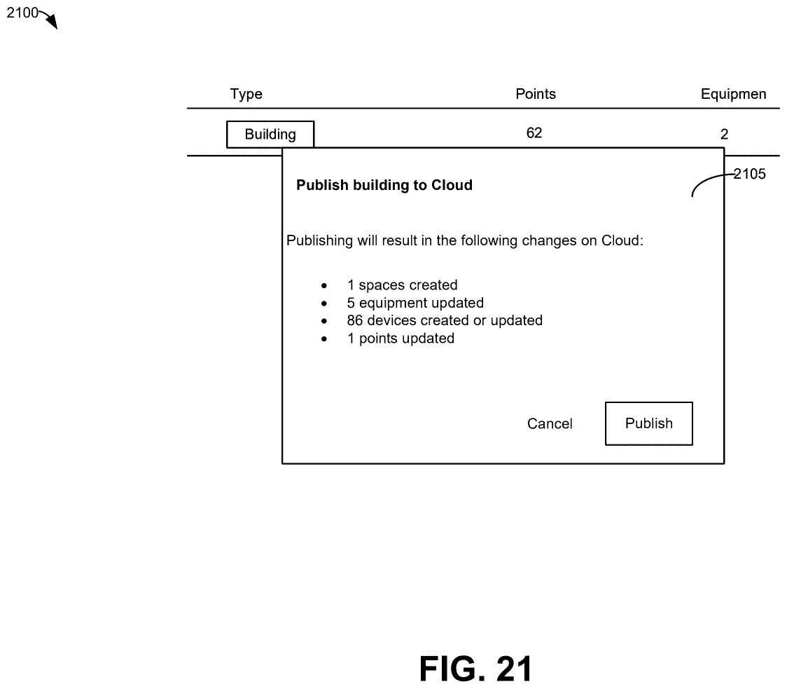

FIG. 21 depicts a user interface 2100, according to some embodiments. In some embodiments, the user interface 2100 may be presented, displayed, or otherwise generated responsive to selection of the element 2015. As shown in FIG. 21, the user interface 2100 includes a window 2105. In some embodiments, the window 2105 may include one or more entries or contents which identify data to publish to the cloud or one or more changes that may occur at the cloud. For example, the window 2105 may identify one or more spaces that may be added to a virtual representation of the building. As another example, the window 2105 may identify one or more devices that have been created or updated.

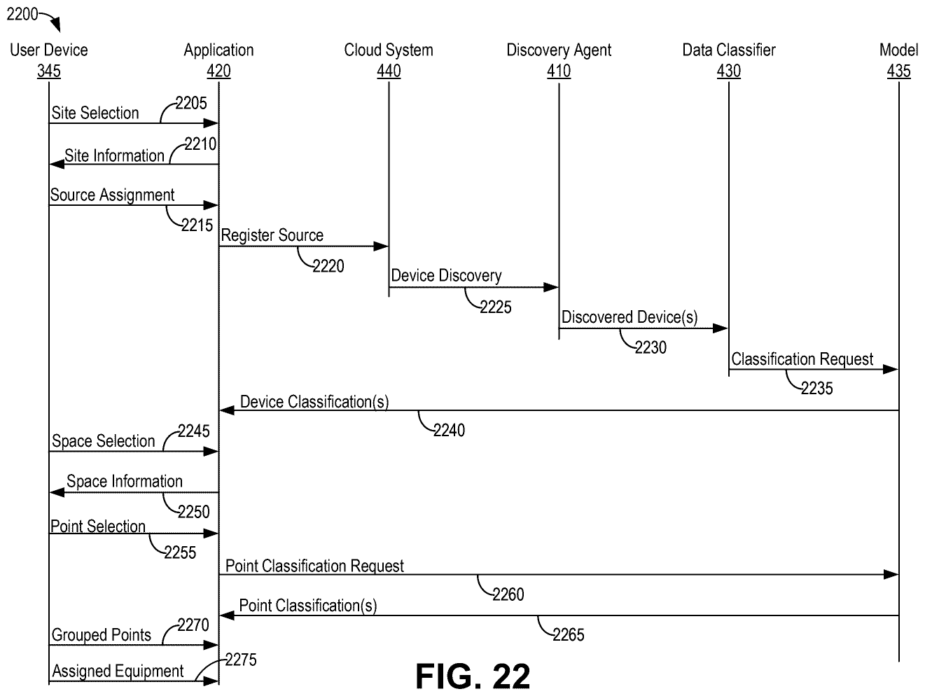

FIG. 22 depicts a sequence diagram illustrating a data flow 2200 between one or more components of the system architecture 400, according to some embodiments. In some embodiments, the data flow 2200 may include one or more components of the system architecture 400 presenting and/or receiving information via one or more user interfaces. For example, the data flow 2200 may include the onboarding application 420 presenting the user interface 500. As another example, the data flow 2200 may include the user device 345 providing information that was input via the input element 810. While FIG. 22 may illustrate the data flow 2200 in a given order and/or pattern, this is for illustrative purposes only and is in no way limiting. For example, one or more steps of the data flow 2200 may be skipped, omitted, combined, repeated, replicated, separated, and/or otherwise changed. As another example, a step that is shown to involve given systems, devices, and/or components may be modified such that different systems, devices, and/or components perform the step. Stated otherwise, performance of the data flow 2200 is not limited to the systems, devices, and/or components illustrated in FIG. 22.

In some embodiments, at step 2205, a selection of a site may be received. For example, the onboarding application 420 may receive information from the user device 345 that indicates a selection within a user interface. As another example, the onboarding application 420 may monitoring interactions with a user interface displayed on the user device 345. In some embodiments, the onboarding application 420 may receive the selection responsive to a selection of the first location 520 in the user interface 500. For example, the onboarding application 420 may detect that the first location 520 was selected from within the user interface 500.

In some embodiments, the onboarding application 420 may retrieve a first set of data responsive to receipt of the selection. For example, the onboarding application 420 may retrieve information from the digital twin 415 (e.g., a virtual representation) that corresponds to the selection (e.g., the first location 520, a building, etc.). In some embodiments, the first set of data may include and/or indicate one or more pieces of building equipment and/or datapoints associated with the building equipment. For example, the first set of data may indicate the equipment 335. As another example, the first set of data may indicate datapoints associated with the equipment 335.

In some embodiments, the first set of data may correspond to previously discovered, previously configured, and/or previously classified information. For example, the first set of data may represent building equipment that was previously integrated into a BMS that services the first location 520. As another example, the first set of data may represent building equipment classified by the ML model 435. In some embodiments, the first set of data may correspond to unclassified equipment and/or datapoints. For example, the first set of data may correspond to equipment that has not yet been classified by the ML model 435.

In some embodiments, at step 2210, site information may be provided. For example, the onboarding application 420 may provide the first set of data to the user device 345. As another example, the onboarding application 420 may cause the user interface 700 to be displayed which may include the first set of information.

In some embodiments, the onboarding application 420 may update the user interface from step 2205 to display the first set of data. For example, the onboarding application 420 may update the user interface to replace the information shown in the user interface 500 with the information shown in the user interface 700. As another example, the onboarding application 420 may present the first set of data as an overlay on top of the user interface 500.

In some embodiments, at step 2215, a source assignment may be received. For example, the onboarding application 420 may receive indications of selection data sources. As another example, the onboarding application 420 may receive information that was provided to the input element 625 and/or the input element 630. To continue this example, the information may indicate a name and/or a location of the data source.

In some embodiments, at step 2220, the source may be registered. For example, the onboarding application 420 may interface with the cloud system 340 to register the data source with the BMS that services the first location 520. As another example, the onboarding application 420 may prompt the cloud system 340 to confirm that the data source is present at and/or associated with the first location 520.

In some embodiments, the onboarding application 420 may receive a selection to search a network of a building. For example, the onboarding application 420 may receive a selection of the element 910 via the user interface 900. In some embodiments, the onboarding application 420 may receive the selection responsive to registration of the source in step 2220. For example, the onboarding application 420 may receive the selection to search the BMS (e.g., network) of the first location 520. In some embodiments, the onboarding application 420 may prompt the cloud system 340, which is in communication with and/or associated with the BMS, to search the network for one or more second pieces of equipment. For example, the onboarding application 420 may prompt the cloud system 340 to search for equipment that may have been previously connected and/or added to the BMS.

In some embodiments, the onboarding application 420 may publish the source assignment to the cloud system 440 in accordance with one or more levels of the spatial hierarchy. For example, the onboarding application 420 may publish the source assignment at a building level (e.g., the information corresponds to the building). As another example, the onboarding application 420 may publish the source assignment at a space level (e.g., the information corresponds to a given space of the building). In some embodiment, the publishing of the information may be automatic and/or manual. For example, the publishing of the information may occur after one or more interactions with a user interface. As another example, the publishing of the information may occur automatically after the receipt of the source assignment. In some embodiments, the automatic publishing of information may be toggled (e.g., turned on and/or turned off) via one or more interactions with a user interface.

In some embodiments, at step 2225, a device may be discovered. For example, the cloud system 340 may prompt the discovery agent 410 to query and/or search the digital twin 415. In some embodiments, one or more devices may be discovered as a result of the discovery agent 410 searching the digital twin 415. For example, the discovery agent 410 may query the digital twin 415 to search for devices that may have been added to the BMS since a previous query of the digital twin 415. In some embodiments, the discovery agent 410 may update the user interface to display a graphical representation of the discovered devices. For example, the discovery agent 410 may cause at least one of the user interfaces 900, 1000, and/or 1200 to be displayed.

In some embodiments, the discovery agent 410 may cause the user interface to indicate (e.g., flag) one or more devices that are unclassified. For example, the discovery agent 410 may cause classified devices to be presented in a first color and unclassified devices to be presented in a second color. As another example, the discovery agent 410 may cause the user interface to include one or more filter elements to limit the results to classified devices and/or unclassified devices.

In some embodiments, at step 2230, discovered devices may be provided. For example, the discovery agent 410 may provide information associated with the devices, discovered in step 2225, to the data classifier 430. In some embodiments, the discovery agent 410 may provide the discovered devices to the data classifier 430 as one or more prompts. For example, the discovery agent 410 may provide a prompt to the data classifier 430 to classifier the devices discovered in step 2225. As another example, the discovery agent 410 may prompt the data classifier 430 by forwarding data strings associated with the discovered devices to the data classifier 430.

In some embodiments, at step 2235, a classification request may be provided. For example, the data classifier 430 may provide a request to the ML model 435. In some embodiments, the request may include providing a prompt to the ML model 435 to generate one or more classifications. For example, the request may cause the ML model 435 to generate classifications of the devices discovered in step 2225. As another example, the request may cause the ML model 435 to generate descriptions for the devices. In some embodiments, the data classifier 430 may provide point names and/or equipment names to the ML Model 435. For example, the data classifier 430 may provide the ML model 435 with a data structure that includes one or more point names and/or equipment names.

In some embodiments, the data classifier 430 may offload and/or utilize the ML model 435 to generate one or more classifications based on point names and/or equipment names that are grouped in a given format or arrangement. For example, the data classifier 430 may provide the ML model 435 with a data structure that includes entries (e.g., the point names and/or equipment names) as one or more rows within the data structure.

In some embodiments, the data classifier 430 may provide the classification request as one or more inputs that include unstructured data names. For example, the data classifier 430 may provide the ML model 435 with unstructured data names that were obtained in step 2225 during device discovery. As another example, the data classifier 430 may prompt the ML model 435 to generate one or more data names that confirm to a standard and/or structured format.

In some embodiments, at step 2240, the device classifications may be provided. For example, the ML model 435 may provide the device classifications to the onboarding application 420. As another example, the ML model 435 may ingest the classifications into the digital twin 415. In some embodiments, the onboarding application 420 may update the user interface to include the device classifications. For example, the onboarding application 420 may update the user interface to display the user interface descriptions of the devices illustrated in the user interface 900.

In some embodiments, at step 2245, a space selection may be received. For example, the onboarding application 420 may receive an indication from the user device 345 of a selected space. As another example, the onboarding application 420 may detect selection of the floor 760 from within the user interface 700.

In some embodiments, at step 2250, space information may be provided. For example, the onboarding application 420 may provide information associated with one or more pieces of equipment that service the space selected in step 2245. As another example, the onboarding application 420 may provide information associated with datapoints that correspond to the space selected in step 2245.

In some embodiments, at step 2255, a point selection may be received. For example, the onboarding application 420 may detect a selection of a point (e.g., entry) included in the user interface 1200. As another example, the onboarding application 420 may receive a prompt that identifies a given point. In some embodiments, the point selection may be associated with an unclassified datapoint. For example, the BMS may be unaware about what the datapoint represents and/or what information may be included in the datapoint.

In some embodiments, at step 2260, a point classification request may be provided. For example, the onboarding application 420 may prompt the ML model 435 to generate a point classification for the selected point in step 2255. As another example, the onboarding application 420 may prompt the ML model 435 to generate classifications for one or more points associated with the space selection in step 2245.

In some embodiments, at step 2265, point classifications may be received. For example, the onboarding application 420 may receive point classifications generated by the ML model 435. As another example, the onboarding application 420 may retrieve point classifications stored in the digital twin 415. In some embodiments, the onboarding application 420 may update the user interface to include the point classifications. For example, the onboarding application 420 may update the user interface to display the user interface 1200.

In some embodiments, the ML model 435 may receive one or more inputs that indicate a performance of the ML model 435. For example, the ML model 435 may receive, in step 2240, an input from the user device 345 that indicates a performance of the ML model 435. Stated otherwise, the ML model 435 may receive an input that indicates whether the device classifications were accurate (e.g., correct). In some embodiments, the ML model 435 may receive inputs that indicate and/or identify given device classifications. For example, the ML model 435 may receive a prompt that identifies a given device classification that was inaccurate (e.g., wrong, incorrect, etc.). To continue this example, the ML model 435 may identify and/or associate the prompt with one or more inputs used by the ML model 435 to generate the given device classification. Stated otherwise, the ML model 435 may identify an unclassified device name and/or data string.

In some embodiments, the ML model 435 may identify and/or detect one or more correlations between the unclassified device and the prompt such that subsequent classifications by the ML model 435 reflect the prompt. For example, the ML model 435 may generate a link between the prompt and the unclassified device such that subsequent detection and/or receipt of the unclassified devices results in the ML model 435 generating a device classification that corresponds to the classification received from the user device 345. Stated otherwise, the ML model 435 may generate one or more second and/or subsequent classifications based on the prompt provided by the user device 345.

In some embodiments, the data classifier 430 may retrain and/or reinforce the ML model 435 based on the prompts and/or inputs provided by the user device 345. For example, the data classifier 430 may adjust one or more weights of the ML model 435 such that subsequent input of the unclassified device cause the ML model 435 to output (e.g., generate) the device classification provided by the user device 345.

In some embodiments, at step 2270, grouped points may be identified. For example, the onboarding application 420 may receive information from the user device 345 that indicates multiple datapoints that are related to one another (e.g., same type of information, correspond to the equipment, follow the same protocol, etc.). In some embodiments, the onboarding application 420 may receive the grouped points responsive to one or more interactions with the user interface. For example, the onboarding application 420 may receive the grouped points based on one or more interactions with the user interface 1200.

In some embodiments, at step 2275, equipment assignments may be received. For example, the onboarding application 420 may receive indications of equipment that were assigned the datapoints classified in step 2265. As another example, the onboarding application 420 may detect information provided to the input elements of the user interface 1300. In some embodiments, the onboarding application 420 may integrate the assigned equipment into the BMS by ingesting the equipment into the digital twin 415.

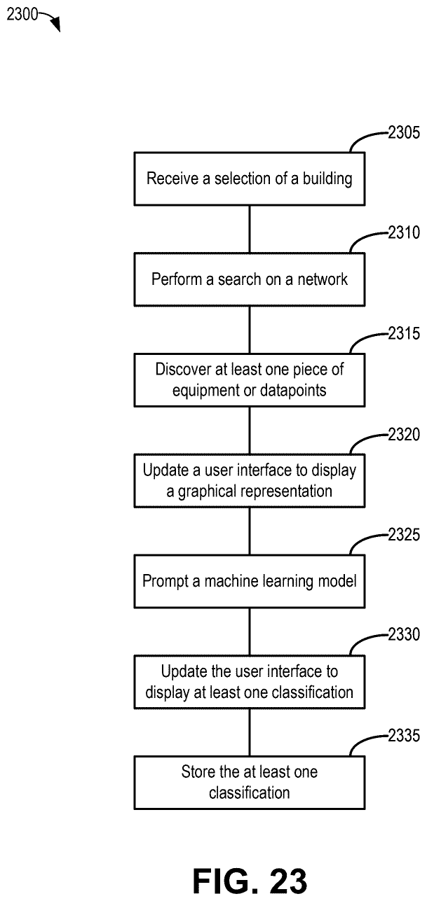

FIG. 23 is a flow diagram of a method 2300 to configure one or more pieces of building equipment or one or more datapoints produced by pieces of building equipment, according to some embodiments. In some embodiments, the method 2300 may one or more steps, acts, processes, or workflows to generate at least one of the classifications or mappings described herein. For example, performance of the method 2300 may result in one or more mappings between pieces of equipment and devices of a building. As another example, performance of the method 2300 may result in one or more mappings between pieces of equipment and spaces of a building. In some embodiments, the method 2300 and/or one or more steps thereof may be repeated, replicated, reproduced, skipped, omitted, combined, separated, or otherwise modified.

In some embodiments, at step 2305, a selection of a building may be received. For example, the processing circuit 310 may receive a selection of a building via one or more interactions with a user interface. As another example, the processing circuit 310 may receive one or more signals from a display device which provide an indication of a selection of a building. In some embodiments, the processing circuit 310 may receive a selection of a building that is displayed or otherwise represented within at least one of the user interfaces described herein. For example, the processing circuit 310 may receive a selection of the building represented by the first location 520. As another example, the processing circuit 310 may receive a selection of the building represented by the building 755.

In some embodiments, the processing circuit 310 may update the user interface to present one or more sets of information associated with the selected building. For example, the processing circuit 310 may update the user interface to present the user interface 700. As another example, the processing circuit 310 may update the user interface to indicate a number of pieces of equipment associated with the selected building, a number of identified or detected points associated with the selected building, or a number of devices connected to a network of the building.

In some embodiments, at step 2310, a search on a network may be performed. For example, the processing circuit 310 may perform a search on a LAN or WAN of the selected building. The processing circuit 310 may perform the search to identify or otherwise detect one or more devices connected to the network. For example, the processing circuit 310 may detect the data sources 350. In some embodiments, the processing circuit 310 may perform the search responsive to one or more prompts or interactions with the user interface. For example, the processing circuit 310 may perform the search responsive to a selection of the element 910. As another example, the processing circuit 310 may perform the search responsive to receipt of one or more signals from a display device which indicate that a request to search the network was received.

In some embodiments, at step 2315, at least one piece of equipment or one or more datapoints may be discovered. For example, the processing circuit 310 may discover equipment (e.g., the equipment 335) that is connected to or otherwise communicably coupled with the discovered devices. Stated otherwise, the discovered devices may be gateways that connect piece of equipment to the network and the piece of equipment is discovered (by the processing circuit 310) responsive to discovery of the gateway. In some embodiments, the processing circuit 310 may discover one or datapoints based on data published or provided by the discovered devices. For example, the gateway may publish datapoints (produced by pieces of equipment of the building) onto the network. The processing circuit 310 may discover the datapoints by querying the network.

In some embodiments, at step 2320, a user interface may be updated to display a graphical representation. For example, the processing circuit 310 may update the user interface to include a visual representation or visual depiction of the detected equipment or the detected datapoints. As another example, the processing circuit 310 may update the user interface to include respective selectable elements that correspond to the discovered equipment or the discovered datapoints. In some embodiments, processing circuit 310 may update the user interface to display at least one of the user interface 1000 or the user interface 1200.

In some embodiments, at step 2325, a machine learning model may be prompted. For example, the processing circuit 310 may provide one or more inputs (to the ML model 435) to prompt the ML model 435 to generated one or more outputs. In some embodiments, the processing circuit 310 may prompt the ML model 435 to generate one or more classifications for the discovered equipment or the discovered datapoints. For example, the ML model 435 may generate a prediction of a standardized object name for a discovered piece of equipment. The standardized object name may describe or otherwise identify the discovered piece of equipment according to a schema or a BMS nomenclature. As another example, the ML model 435 may generate a mapping between a native reference and a datapoint name.

In some embodiments, at step 2330, the user interface may be updated to display at least one classification. For example, the processing circuit 310 may update the user interface to present the classifications generated by or output by the ML model 435. As another example, the processing circuit 310 may present an overlay that includes a text box to present the classifications generated by the ML model 435. In some embodiments, the processing circuit 310 may update the user interface to include a list of names (which were mapped from native reference strings for discovered datapoints).

In some embodiments, at step 2335, the at least one classification may be stored. For example, the processing circuit 310 may store the classifications for the equipment responsive to acceptance or confirmation of the classifications. In some embodiments, the processing circuit 310 may receive one or more signals or inputs which provide confirmation of the classifications. For example, selection one or more datapoints (e.g., entries) of the user interface 1200 may trigger presentment of a prompt to accept or adjust the classifications for the datapoints. The processing circuit 310 may receive confirmation of the classifications responsive to selection of an accept icon or element that is included within the prompt. In some embodiments, the processing circuit 310 may store the classifications in one or more databases. For example, the processing circuit 310 may store the classifications in the digital twin 415. As another example, the processing circuit 310 may store the classifications in the cloud system 340.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures show a specific order of method steps, the order of the steps may differ from what is depicted. Also, two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

What is claimed is:

1. A Building Management System (BMS) comprising one or more memory devices storing instructions thereon that, when executed by one or more processors, cause the one or more processors to:
receive, via a user interface, a selection of a building;
perform, responsive to receipt of a request via the user interface, a search on a network of the building for a plurality of pieces of equipment or a plurality of datapoints associated with the plurality of pieces of equipment;
discover, responsive to performance of the search on the network, at least one piece of equipment of the plurality of pieces of equipment or one or more datapoints of the plurality of datapoints;
update the user interface to display a graphical representation of the at least one piece of equipment or the one or more datapoints;
prompt a machine learning model to generate at least one classification for the at least one piece of equipment or the one or more datapoints;
update, responsive to generation of the at least one classification, the user interface to display the at least one classification; and
store, responsive to an acceptance of the at least one classification, the at least one classification in a database associated with the building to integrate the at least one piece of equipment or the one or more datapoints with the building.

2. The BMS of claim 1, wherein at least one second piece of equipment of the plurality of pieces of equipment is integratable with the building without a subsequent selection of the building via the user interface.

3. The BMS of claim 1, wherein the instructions cause the one or more processors to:
receive, via the user interface, a second selection to display a spatial hierarchy of the building;
retrieve, responsive to receipt of the second selection, a set of data that represents the spatial hierarchy of the building;
display, via the user interface, a graphical representation of the spatial hierarchy of the building;
receive, via the user interface, an input to add a space to the spatial hierarchy of the building; and
update, responsive to receipt of the input, the spatial hierarchy to include the space.

4. The BMS of claim 3, wherein the update to the spatial hierarchy occurs without a subsequent selection of the building via the user interface.

5. The BMS of claim 1, wherein the at least one classification includes a first classification associated with the at least one piece of equipment and a second classification associated with the one or more datapoints, and wherein the instructions cause the one or more processors to:
receive, via the user interface, a second selection of the graphical representation of the at least one piece of equipment;
update, responsive to receipt of the second selection, the user interface to display the first classification and the second classification; and
receive, via the user interface, a third selection of an element to indicate the acceptance of the at least one classification.

6. The BMS of claim 1, wherein the database associated with the building includes (1) a first classification of at least one previously discovered piece of equipment and (2) a second classification of at least one datapoint associated with the at least one previously discovered piece of equipment, and wherein the instructions cause the one or more processors to:
receive, via the user interface, a second selection of the at least one previously discovered piece of equipment;
update, responsive to receipt of the second selection, the user interface to display the first classification and the second classification;
receive, via the user interface, an adjustment to the first classification or the second classification; and
update the database associated with the building to reflect the adjustment without a subsequent selection of the building via the user interface.

7. The BMS of claim 1, wherein the database associated with the building includes a virtual representation of the building, wherein the virtual representation of the building is a digital twin, and wherein the instructions cause the one or more processors to:
detect, responsive to a query of the digital twin, one or more changes with respect to the building; and
prompt the machine learning model to generate one or more mappings to reflect the one or more changes.

8. The BMS of claim 7, wherein the one or more changes include at least one of:
an addition of a first piece of building equipment to the building;
a removal of a second piece of building equipment from the building; or
an adjustment to a classification between at least one datapoint and a third piece of building equipment.

9. The BMS of claim 1, wherein the user interface provides, prior to receipt of the selection of the building, a first view that includes (1) an indication of the building and (2) an indication of information associated with the building, and wherein the instructions cause the one or more processors to:
update, responsive to receipt of the selection, the user interface to provide a second view that includes:
a first element associated with one or more spaces of the building;
a second element associated with one or more devices of the building;
a third element associated with at least one previously discovered datapoint; and
a fourth element associated with at least one previously discovered piece of equipment;
receive, via the user interface, a selection of the fourth element;
update the user interface to include (1) information associated with the at least one previously discovered piece of equipment and (2) a fifth element to interact with to provide the request to search the network of the building; and
receive the request to search the network of the building responsive to an interaction with the fifth element.

10. The BMS of claim 1, wherein the at least one piece of equipment is discovered as a first unstructured object name, wherein the one or more datapoints are discovered as a second unstructured object name, wherein the first unstructured object name and the second unstructured object name are provided to the machine learning model as one or more inputs, and wherein the machine learning model generates the at least one classification by:
generating a plurality of standardized object names based on the one or more inputs;
determining a probability for each standardized object name of the plurality of standardized object names that indicates a likelihood that a corresponding standardized object name is associated with the first unstructured object name or the second unstructured object name; and
selecting, based on the probability for each standardized object name of the plurality of standardized object names, at least one standardized object name as the at least one classification.

11. One or more non-transitory storage media having instructions thereon that, when executed by one or more processors, cause the one or more processors to perform operations comprising:
performing, responsive to receiving a request via a user interface, a search on a network of a building for a plurality of pieces of equipment or a plurality of datapoints;
discovering, responsive to performing the search on the network, at least one piece of equipment of the plurality of pieces of equipment or one or more datapoints of the plurality of datapoints;
updating the user interface to display a graphical representation of the at least one piece of equipment or the one or more datapoints;
prompting a machine learning model to generate at least one classification for the at least one piece of equipment or the one or more datapoints;
updating, responsive to generating the at least one classification, the user interface to display the at least one classification; and
storing, responsive to an acceptance of the at least one classification, the at least one classification in a database associated with the building to integrate the at least one piece of equipment or the one or more datapoints with the building.

12. The one or more non-transitory storage media of claim 11, wherein at least one second piece of equipment of the plurality of pieces of equipment is integratable with the building without a subsequent selection of the building via the user interface.

13. The one or more non-transitory storage media of claim 11, wherein the operations further comprise:
receiving, via the user interface, a selection to display a spatial hierarchy of the building;
retrieving, responsive to receiving the selection, a set of data that represents the spatial hierarchy of the building;
displaying, via the user interface, a graphical representation of the spatial hierarchy of the building;
receiving, via the user interface, an input to add a space to the spatial hierarchy of the building; and
updating, responsive to receiving the input, the spatial hierarchy to include the space.

14. The one or more non-transitory storage media of claim 11, wherein the at least one classification includes a first classification associated with the at least one piece of equipment and a second classification associated with the one or more datapoints, and wherein the operations further comprise:
receiving, via the user interface, a first selection of the graphical representation of the at least one piece of equipment;
updating, responsive to receiving the first selection, the user interface to display the first classification and the second classification; and
receiving, via the user interface, a second selection of an element to indicate the acceptance of the at least one classification.

15. The one or more non-transitory storage media of claim 11, wherein the database associated with the building includes (1) a first classification of at least one previously discovered piece of equipment and (2) a second classification of at least one datapoint associated with the at least one previously discovered piece of equipment, and wherein the operations further comprise:
receiving, via the user interface, a selection of the at least one previously discovered piece of equipment;
updating, responsive to receiving the selection, the user interface to display the first classification and the second classification;
receiving, via the user interface, an adjustment to the first classification or the second classification; and
updating the database associated with the building to reflect the adjustment without a subsequent selection of the building via the user interface.

16. The one or more non-transitory storage media of claim 11, wherein the database associated with the building includes a virtual representation of the building, wherein the virtual representation of the building is a digital twin, and wherein the operations further comprise:
detecting, responsive to querying the digital twin, one or more changes with respect to the building; and
prompting the machine learning model to generate one or more mappings to reflect the one or more changes.

17. The one or more non-transitory storage media of claim 11, wherein the user interface provides a first view that includes (1) an indication of the building and (2) an indication of information associated with the building, and wherein the operations further comprise:
updating the user interface to provide a second view that includes:
a first element associated with one or more spaces of the building;
a second element associated with one or more devices of the building;
a third element associated with at least one previously discovered datapoint; and
a fourth element associated with at least one previously discovered piece of equipment;
receiving, via the user interface, a selection of the fourth element;
updating the user interface to include (1) information associated with the at least one previously discovered piece of equipment and (2) a fifth element to interact with to provide the request to search the network of the building; and
receiving the request to search the network of the building responsive to an interaction with the fifth element.

18. A Building Management System (BMS) comprising one or more memory devices storing instructions thereon that, when executed by one or more processors, cause the one or more processors to:
provide, via a display device, a user interface having a first view, wherein the first view includes (1) an indication of a building associated with the BMS and (2) an indication of information associated with the building;
receive, via the user interface, a first selection of the building;
update the user interface to have a second view, wherein the second view includes a spatial hierarchy of the building;
receive one or more subsequent interactions with the user interface having the second view, wherein the one or more subsequent interactions include at least one of (1) one or more updates to the spatial hierarchy of the building or (2) one or more integrations of equipment and/or datapoints with the BMS; and
generate an association between the one or more subsequent interactions and the building without a second selection of the building.

19. The BMS of claim 18, wherein the instructions cause the one or more processors to generate the association between the one or more subsequent interactions and the building by:
updating a database associated with the building to include the one or more updates to the spatial hierarchy or the one or more integrations of the equipment and/or the datapoints with the BMS.

20. The BMS of claim 18, wherein the one or more subsequent interactions include the one or more integrations of the equipment and/or the datapoints with the BMS, and wherein the instructions cause the one or more processors to generate the association between the one or more subsequent interactions and the building by:
prompting a machine learning (ML) model to generate one or more classifications for the equipment or the datapoints;
updating, responsive to generation of the one or more classifications, the user interface to display the one or more classifications; and
storing, responsive to an acceptance of the one or more classifications, the one or more classifications in a database associated with the building to integrate the equipment and/or the datapoints with the BMS.
